(19) United States
(12) Patent Application Publication
(10) Pub. No.: US 2026/0087639 A1
(43) Pub. Date: Mar. 26, 2026

(54) SELECTING A CAMERA PERSPECTIVE TO CONVEY A PERSPECTIVE OF DEPTH

(71) Applicant: Adeia Guides Inc., San Jose, CA (US)

(72) Inventors: Ning Xu, Irvine, CA (US); Zhiyun Li, Kenmore, WA (US)

(21) Appl. No.: 18/897,625

(22) Filed: Sep. 26, 2024

(51) Int. Cl. G06T 7/20

(52) U.S. Cl. CPC G06T 7/20; G06T 2207/10016; G06T 2207/30224; G06T 2207/30241

(57) ABSTRACT

Real-time video data of an object, for example, a ball, may be captured by a video camera and, based on a determined position of the object in three-dimensional (3D) space with respect to a surface (e.g., a ballfield), a graphic indicating on the surface a position of the object directly overhead may be inserted in the video data. A graphic indicating on the surface the overhead trajectory of the airborne object and/or a predicted landing spot of the object on the surface may be inserted. Also described is a method for camera selection. A real time trajectory of the object in 3D space is determined. A target camera perspective for capturing the trajectory of the object may be selected based at least in part on an apparent size of the object, a parallax effect of the object, or a viewable portion of the trajectory of the object.

### BACKGROUND

The present disclosure relates to computer implemented techniques for generating graphics for video data and for selecting physical and/or virtual camera angles based on computed trajectories of airborne objects.

### SUMMARY

Video cameras output video data that provides a two-dimensional (2D) representation of three-dimensional (3D) objects in the real world. A technological problem that arises is that such video data often fails to reliably convey depth due to the limits of 2D video imagery. For example, when a video depicts a ball airborne, the video often fails to convey 3D information about the ball, including where on the surface the ball is tracking. FIGS. 3A-B and 4A-4B show that, due to the limitations in conveying depth in the view provided by a camera, the video data fails to convey the position of the object with respect to the 2D surface. Video images captured by a single video camera typically fail to convey stereoscopic views. The video data fails to convey clearly the position of the object 105 in relation to the surface below.

This problem is exacerbated by the fact that the camera angle may be suboptimal for capturing video data that conveys the position of the ball, and it may be difficult to adjust such camera angle in time to capture, in real time, a view of the airborne ball. Such videos may cause confusion regarding game dynamics, particularly in fast-paced sports such as football or soccer, in which understanding the ball's precise location and trajectory are crucial for appreciating player movement on the ground in response to the ball's movement and other tactical elements of the game.

Augmented reality (AR) has revolutionized sports broadcasting through visual aids and real-time data overlays. A notable example is the yellow first-down line graphic inserted on the American football gridiron, which debuted in 1998. This AR technology superimposes a virtual line on the football field to indicate the first down marker, making it easier for viewers to follow the game. Over time, this technology has evolved to incorporate real-time data and 3D animations, further enriching the broadcast with detailed and dynamic visuals.

To help address the problems that persist, according to an aspect of the disclosure, the position of a ball in 3D space, for example, during a live broadcast of a sports game, is detected (e.g., using one or more sensors in the ball and/or based on video data from multiple cameras), and a graphic is inserted in the video to show the position of a spot on the ground or other surface directly beneath the ball in the air. The graphic may be positioned on a spot on the surface directly beneath the position of the object in 3D space. In this way, the failure of the video data to convey the position of the ball in 3D may be mitigated. The graphic may appear as a spot on the ground or may be a different shape, size and/or color. While discussed with reference to a ball, it will be understood that the perception of the location or movement of other types of objects may also be facilitated using the methods herein discussed. The term ball as used herein may mean a shuttlecock, a discus, a javelin, an arrow, a bullet, and objects other than sporting objects, such as an airplane, a rocket, fireworks, a balloon, and other types of airborne and non-airborne objects.

According to some embodiments, the trajectory of the ball may be computed and graphics indicating the predicted landing site of the ball on the ground and/or the trajectory of the ball and/or the predicted remaining trajectory of the ball in the air before landing may be inserted into the video. In addition, or in the alternative, graphics indicating one or more vertical lines extending from the ball and/or from the trajectory of the ball to the ground may be rendered in the video data to show the location of the ball and its trajectory with respect to the ground.

According to another aspect of the disclosure, a new or updated camera perspective (e.g., position and/or orientation) may be selected for capturing the ball as it moves through its trajectory. Image data of the ball is captured using two or more physical cameras, and a trajectory of the ball may be predicted. The position and orientation (e.g., angle in 3D space) of each of the cameras may be known in advance. Virtual camera image data may also be generated based at least in part on the physical camera image data obtained from the two physical cameras. Based at least in part on various factors, for example:
an apparent size of the ball captured in the image data;
a motion parallax for the ball (e.g., determined by simulated movement of the camera),
a portion of the trajectory of the ball within the field of view of each of the cameras;
an occluded portion of the trajectory of the ball,
   an optimized, or at least an improved, camera angle (e.g., camera location and orientation in 3D space) may be determined.

For example, the system may determine a physical or virtual camera orientation from which video of the airborne ball will be captured through most or all of the trajectory without undue occlusion of its field of view and such that the video will convey at least to some extent the position of the ball with respect to the ballfield below.

Once a new camera perspective is determined, one or more physical cameras may be moved to the optimized or improved position, and/or virtual camera image data from the optimized or improved position may be used. Thus, the video data provided from the selected, improved position of the camera may be physical camera data or virtual camera data. Thus, the selected, improved position of the camera may enhance the perception of the ball as it moves through its predicted trajectory.

According to a further embodiment, one or more intermediate camera positions may be computed between the original camera vantage point and the selected improved camera position. A smooth, gradual transition may be rendered starting from the original camera to the selected improved camera position. Further, after the ball lands, or while the ball is still in the air (e.g., when the ball is at the apex of its trajectory), such a smooth, gradual transition may be rendered starting from the selected improved camera position back to the original camera.

Methods, systems, non-transitory computer-readable media, and means for implementing the methods are disclosed for generating graphics. Such methods may include: receiving real-time video data of an object, such that the real-time video data is captured by a camera; determining a location of the object in three-dimensional (3D) space with respect to a surface; and inserting a graphic in the video data indicating a position of a spot on the surface directly underneath the object. For example, directly underneath may mean that the graphic may appear on the surface to be within a threshold of 1-5 m, or 0.1-20 m, of a spot directly beneath the airborne object.

In addition, or instead, a graphic may be inserted (e.g., overlaid) in the video data indicating on the surface a line corresponding to an overhead trajectory of the airborne object. A predicted landing spot of the object on the surface may be inserted based at least in part on prediction of the position and a motion of the object. For example, the trajectory of the object may be predicted by computing at least two coordinates in the 3D space indicating successive positions of the object and determining a time interval between the at least two coordinates. Such a trajectory graphic cast on the surface may indicate on the surface the past trajectory and the predicted future trajectory until the landing spot. The trajectory of the object in the 3D space may be determined based at least in part on data received from one more sensors in, on or at the object. The trajectory of the object may be determined in the 3D space based at least in part on the real-time video data captured by the camera. The trajectory of the object may be determined based at least in part on the position and a motion of the object in the 3D space, and a landing time of the object may be predicted according to the determined trajectory of the object. Accordingly, a graphic indicating on the surface a future trajectory of the object may be generated.

Also contemplated are methods, systems, non-transitory computer-readable media, and means for implementing the methods for selecting video camera. Such methods may include: receiving first image data captured from a first perspective by a first physical camera and second image data captured from a second perspective by a second physical camera, wherein the first image data and the second image data indicate a sequence of object positions in (3D) space; predicting in real time a trajectory of the object in the 3D space; for each of the first image data and the second image data: determining an apparent size of the object; determining a parallax effect for the object by a simulated shift in angle of a respective camera; and determining a viewable portion of the trajectory of the object; selecting, as a selected camera, one of the first physical camera or the second physical camera based at least in part on the determined apparent size of the object, the determined motion parallax effect for the object, or the determined viewable portion of the trajectory of the object; and receiving, using the selected camera, new image data of at least a portion of the trajectory of the object.

Such methods may also entail providing a gradual transition between the original camera video feed and the selected camera video feed. For example, at least one intermediate perspective between a perspective of the selected camera and an original camera angle may be determined; and the intermediate camera image data of the object from the at least one intermediate perspective may be received before the receiving the new image data of the object from the selected camera.

The trajectory of the object in the three-dimensional space may be predicted based at least in part on data received from one more sensors in, on or at the object. In addition, or instead, the trajectory of the object in the three-dimensional space may be predicted based at least in part on the first image data or the second image data.

In such methods, the apparent size of the object may be determined based at least in part on a pixel count in one or more video frames. The viewable portion of the trajectory of the object may be determined, for example, with respect to an entirety of the trajectory of the object. In addition, or instead, the viewable portion of the trajectory of the object may be determined based at least in part on a visibility of the trajectory of the object in a field of view from a camera perspective and based at least in part on one or more obstructions determined in the field of view from the camera perspective. The selected camera may be repositioned and/or reoriented according to the determined camera perspective.

In an implementation, a virtual camera perspective may be selected as the target camera perspective based on which physical camera perspective is first selected as the selected camera. For example, such a target virtual camera perspective may represent an improved camera perspective. In an implementation, such a target camera perspective may be determined by evaluating an objective value for image data computed for first virtual cameras at a first distance from the selected physical camera, wherein the objective value is computed based at least in part by determining an apparent size of the object, determining a parallax effect for the object based at least in part on an analysis of the respective image data compared with update image data computed by a simulated change in angle of a respective virtual camera, and determining a viewable portion of the trajectory of the object; selecting as a first candidate virtual camera the virtual camera with a greater objective value; computing a second distance less than the first distance; evaluating the objective value for image data computed for second virtual cameras at the second distance from the candidate virtual camera, wherein the objective value for the image data of each virtual camera in the same manner as above described; determining that the image data of one virtual camera of the second virtual cameras has the objective value greater than the objective value of the image data of the first candidate virtual camera; and selecting the one virtual camera of second candidate virtual cameras as the target virtual camera.

The trajectory of the object may be predicted by computing at least two coordinates in 3D space indicating successive positions of the object, and determining a time interval between the at least two coordinates.

The target camera perspective determination method may also include generating a graphic indicating on the surface an overhead position of the airborne object. Accordingly, such a method may include: receiving real-time video data of an object, wherein the real-time video data is captured by a camera; determining, based at least in part on a position of the object, a position of the object in 3D with respect to a surface; and inserting a graphic in the video data indicating a position of a shadow of the object on the surface, wherein the graphic indicates a position on the surface directly underneath the object.

Further contemplated are a method, system, non-transitory computer-readable medium, and means for implementing the method for selecting a video camera. Such a method may include: receiving first video data captured from a first camera perspective by a physical camera; predicting in real time a trajectory of the object in 3D space; selecting a target camera perspective for capturing the trajectory of the object based at least in part on an apparent size of the object from a plurality of candidate camera perspectives, a parallax effect of the object from a plurality of candidate camera perspectives, or a viewable portion of the trajectory of the object from a plurality of candidate camera perspectives; and receiving new video data from the selected target camera perspective.

In such methods, determining a virtual camera perspective may then be determined based on the selected physical camera perspective.

The present invention is not limited to the combination of the elements as listed herein and may be assembled in any combination of the elements as described herein. These and other capabilities of the disclosed subject matter will be more fully understood after a review of the following figures, detailed descriptions, and claims.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates an example of a graphic showing a spot on the surface below the airborne object 105 and a trajectory graphic of an object projected on a surface, illustrated, by way of example, as a television frame of a soccer game, according to an example of an aspect of some embodiments of the present disclosure;

FIG. 2 illustrates an example of the video frame with the spot graphic of a soccer ball in a soccer game, according to an example of an aspect of some embodiments of the present disclosure;

FIGS. 3A-3B illustrate video frames that do not clearly convey the position of the airborne soccer ball in relation to the soccer field below.

FIGS. 4A-4B illustrate, respectively, a video frame showing a gridiron American football field and a soccer video game image, with graphics showing various features of the fields;

FIG. 5 illustrates an example of the video frame with the trajectory graphic on the surface of a soccer ball in a soccer game, according to an example of an aspect of some embodiments of the present disclosure;

FIG. 6 illustrates an example of the video frame with the trajectory graphic of a soccer ball in a soccer game and a trajectory graphic, according to an example of an aspect of some embodiments of the present disclosure;

FIG. 7 illustrates a computer system for implementing methods described herein, according to an example of an aspect of some embodiments of the present disclosure;

FIG. 8 illustrates a system for implementing methods described herein, according to an example of an aspect of some embodiments of the present disclosure;

FIG. 9 is a flowchart that illustrates an example of a process for graphic positioning and generation, according to an example of an aspect of some embodiments of the present disclosure;

FIG. 10 is a flowchart that illustrates a process for graphic tracking and calculation, according to an example of an aspect of some embodiments of the present disclosure;

FIG. 11 is a flow diagram that illustrates an example of a process for communication flow and processing for airborne object detection and tracking, according to an example of an aspect of some embodiments of the present disclosure;

FIG. 12 is a flow diagram that illustrates an example of a process for communication flow and processing for surface location processing, according to an example of an aspect of some embodiments of the present disclosure;

FIG. 13 is a flow diagram that illustrates an example of a process for communication flow and processing for determining whether to generate the graphic, according to an example of an aspect of some embodiments of the present disclosure;

FIG. 14 is a flow diagram that illustrates an example of a process for communication flow and processing for determining position of the graphic to be inserted, according to an example of an aspect of some embodiments of the present disclosure;

FIG. 15 is a flow diagram that illustrates an example of a process for communication flow and processing for surface foreground processing, according to an example of an aspect of some embodiments of the present disclosure;

FIG. 16 is a flow diagram that illustrates an example of a process for communication flow and processing for graphic insertion, according to an example of an aspect of some embodiments of the present disclosure;

FIG. 17 shows an example of an object airborne over a surface with video camera positioned on the ground and on an airborne drone, as well as virtual camera perspectives trained on the airborne object, according to an example of an aspect of some embodiments of the present disclosure;

FIG. 18A illustrates an example of camera perspective selection, according to an example of an aspect of some embodiments of the present disclosure;

FIG. 18B illustrates an example of a quantification process for measuring the parallax effect based on background offset, according to an example of an aspect of some embodiments of the present disclosure;

FIG. 19 is a flowchart that illustrates an example of a process for target camera perspective selection, according to an example of an aspect of some embodiments of the present disclosure; and

FIG. 20 is a flow diagram that illustrates a process for localizing a SLAM-enabled device and for collecting attributes of the SLAM-enabled device, according to an aspect of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

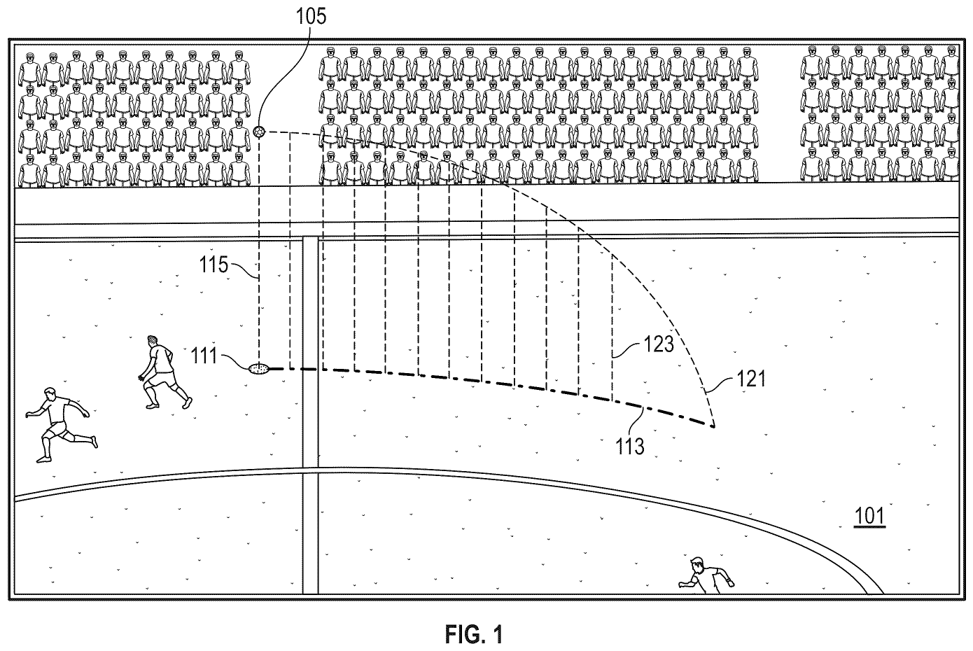

FIG. 1 illustrates an example of a virtual spot graphic 111 projected onto a 2D field mesh surface 101 (illustrated herein as a soccer field) based on a position of an object 105 (shown as a ball by way of example) airborne above. This may occur, for example, during a media asset, such as, for example, a sports broadcast or stream or other live event captured by video cameras. The system may determine a position of the airborne object (ball) 105 using one or more methods. The virtual graphic 111 may be generated based on real-time tracking of the object 105. For example, object (ball) 105 may be airborne due to being kicked or headed by a player participating in the soccer game. The graphic 111 may be positioned on the surface 101 directly under the airborne object 105. While sometimes graphic 111 is referred to as a “shadow” graphic, the position of the graphic 111 may be determined regardless of the position of light sources and actual shadows that the object 105 may cast. For example, if the surface is denoted with x and y coordinates and the distance from the surface is denoted on a z axis with the surface at z=0, then the location of the graphic 111 on the surface 101 may be z=0 with the same x, y coordinates as the x, y coordinates of the object 105.

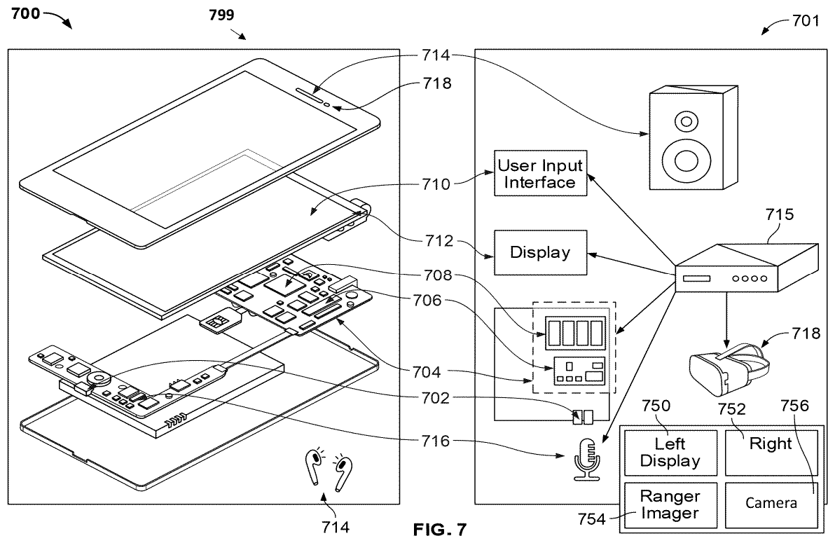

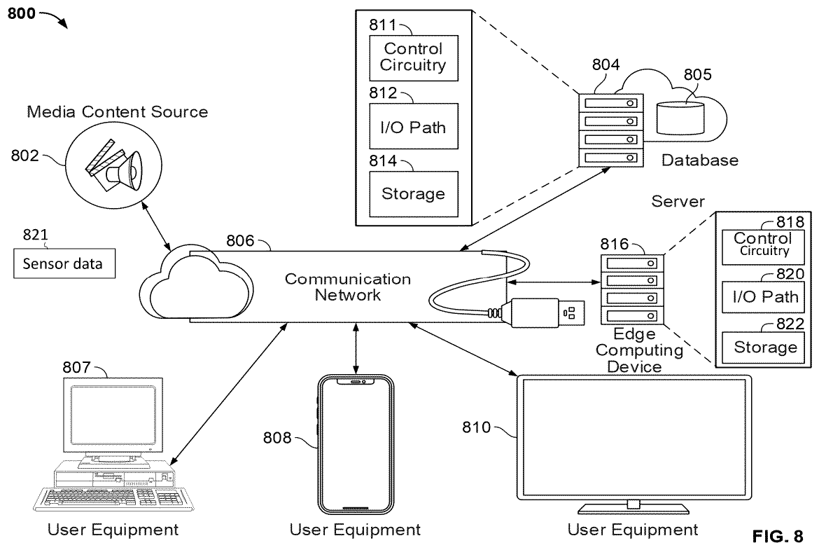

The system may be executed at least in part on a client computing device (e.g., 700, 701 of FIG. 7) and/or at one or more remote servers (e.g., server 804 of FIG. 8 and/or media content source 802 of FIG. 8), which may utilize storage devices (e.g., database 805 of FIG. 8, and/or at or distributed across any of one or more other suitable computing devices, in communication over any suitable number and/or types of networks (e.g., the Internet). The system may comprise or employ any suitable number of displays, sensors or devices such as those described in the figures, or any other suitable software and/or hardware components, or any combination thereof.

The graphic 111 may have the dark appearance (or any other suitable appearance to contrast with or to be visible on surface 101) and/or size of what the object's apparent shadow may look like or may be highlighted and sized to be readily visible. In an embodiment, the size of the graphic is consistent regardless of the apparent size of the object 105 in the frame. In an embodiment, the size of the graphic 111 changes in proportion to the apparent size of the object 105 in the frame. In an embodiment, the shadow projection may be initiated only when the object 105 reaches a certain height, for example, a threshold height of 2-20 m, or 0.3-100 m, so as reduce wasteful use of computing resources (e.g., when the object 105 remains visible to a user consuming the media asset) and unnecessary visual clutter.

The system may obtain the 3D location of the object 105 using a computer vision algorithm by tracking the object across multiple cameras. In an embodiment, multiple high-speed cameras with known locations may be set up around and/or over the surface 101. The cameras may be stationary (e.g., a camera attached to goal post) or mobile, e.g., a camera incorporated in a drone, or may be operated by a cameraman or may operate automatically. While sometimes referred to as a field, it will be understood that the area of surveillance may be any type of surface and airborne objects above or near it. Such a surface may include a tennis or basketball court, a table in a table tennis (ping-pong), a hockey rink, a balloon testing area, a grass or astroturf field in a soccer or football game, a hardwood or blacktop court in a basketball game, sand in a beach volleyball game, or any other suitable surface in any suitable event or video. The cameras may cover different angles to maximize field of view of the soccer field while minimizing occlusions.

Each camera may be intrinsically and extrinsically calibrated to register its position, orientation (angle with respect to the X, Y and Z-axes) and lens characteristics. Calibration may include determining each camera's internal parameters (focal length, optical center) and external parameters (position and orientation relative to a global coordinate system). If a camera changes its position or angle of view/orientation, such change may be notified to the system and registered with the system in real time. The cameras may capture frames at a high frame rate for smooth tracking of a fast-moving objects, such as the object 105.

In addition, or instead, the object position may be determined using sensors such as ultra-wideband (UWB) technology that may use a low energy level for short-range, high-bandwidth communications to collect positional data continuously and/or an inertial measurement unit (IMU) embedded in or on, or at the object 105. The UWB may provide accurate distance measurements to fixed anchors around the field, while the IMU may provide acceleration and orientation data. A sensor fusion algorithm, such as a Kalman filter, may be employed to combine accelerometer, gyroscope, and magnetometer data for more accurate motion tracking.

Real-time 3D location data of the object 105 may be transmitted to a server (e.g., server 804 of FIG. 8) with a high-speed and low latency network. In an embodiment, computer vision-based 3D object tracking may be used in conjunction with ball-borne sensor tracking to provide robust and accurate real time results with redundancy. Radar may also be used to track the position of the moving object 105.

As shown in FIG. 1, the trajectory of the object may be computed, for example, based on the initial and current positions of object 105, and along the trajectory, a graphic 121 may be generated to indicate more visibly the direction of object movement. A second graphic 113 may be generated on the 2D surface 101 directly under the trajectory where the object 105 has flown over. Vertical lines 123 indicate the link of the positions of the object 105 along its trajectory in the air with corresponding positions on the 2D surface 101 along the second graphic 113. A vertical line 115 links the position of the airborne object 105 with the graphic 111 on the surface 101 directly underneath.

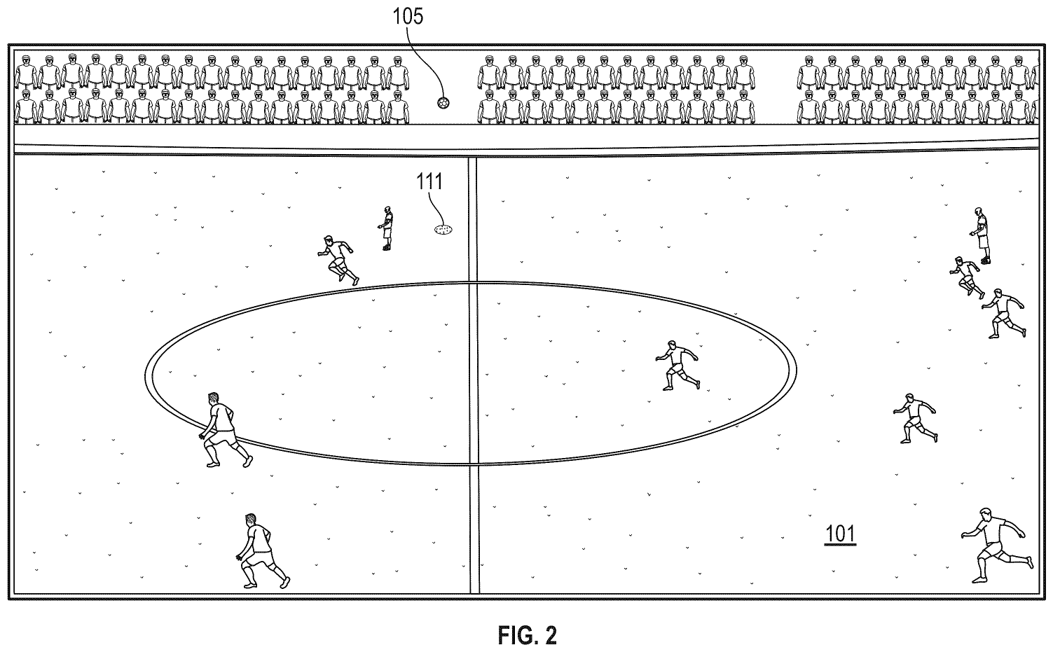

FIG. 2 illustrates the virtual graphic 111 projected onto the 2D surface 101 based on a position of the airborne object 105. In this way, the video frame may convey the position of the object 105 in relation to events below.

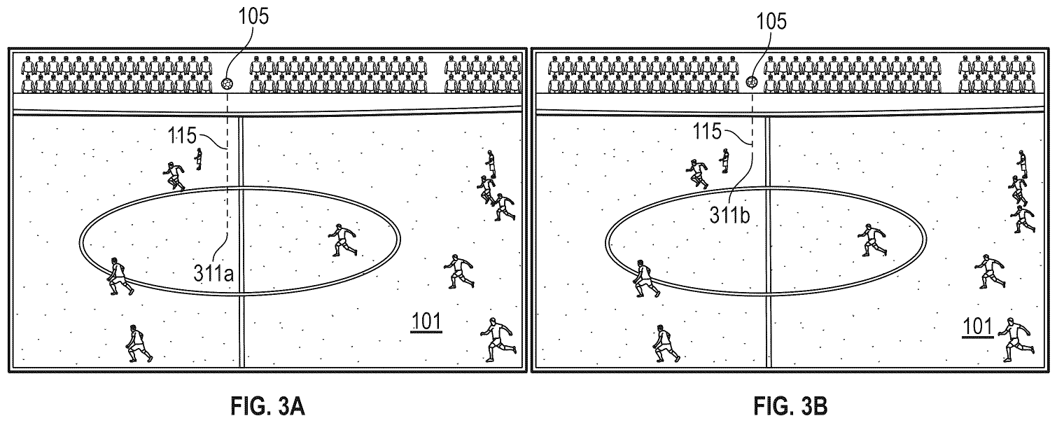

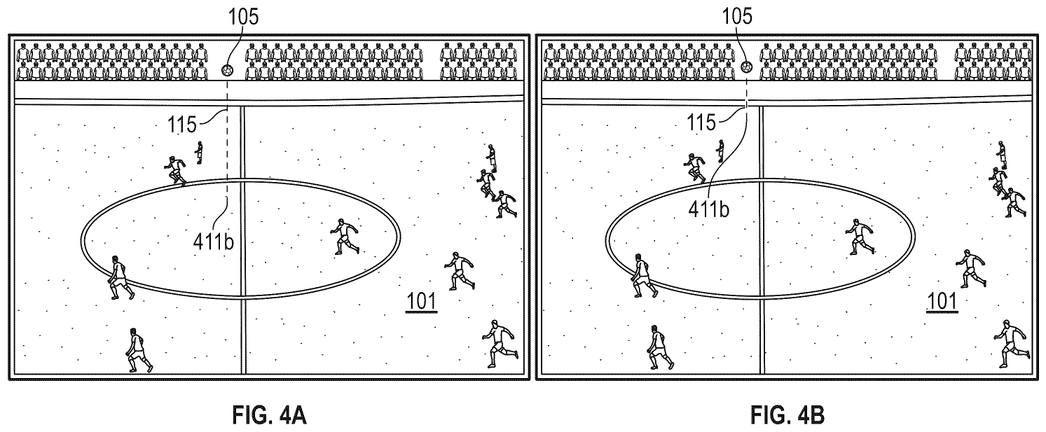

As shown in FIGS. 3A-4B, video images captured by a single video camera typically fail to convey stereoscopic views. The video data fails to convey clearly whether the object is over points 311a, 311b, 411a, 411b or over some point in between these points on the surface 101 below.

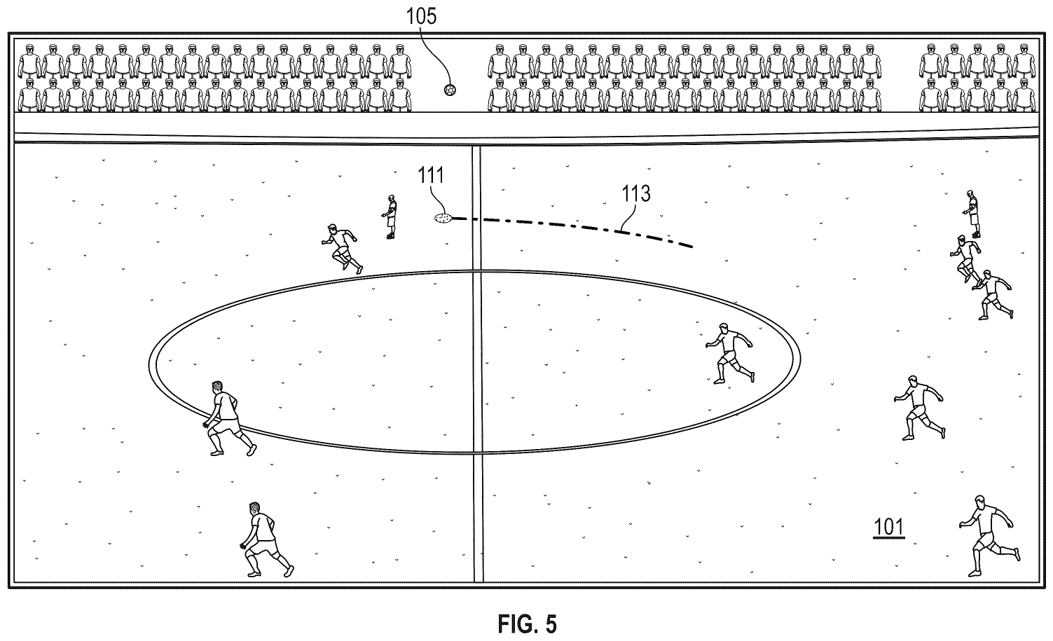

FIG. 5 illustrates the virtual graphic 111 projected onto the 2D surface 101 based on a position of the object 105 together with the second graphic 113 positioned on the 2D surface 101 showing where the object 105 has flown over in its determined trajectory. The system may inject this second graphic 113 to aid in perceiving both the movement of the object over the surface 101 and the current position of the object 105.

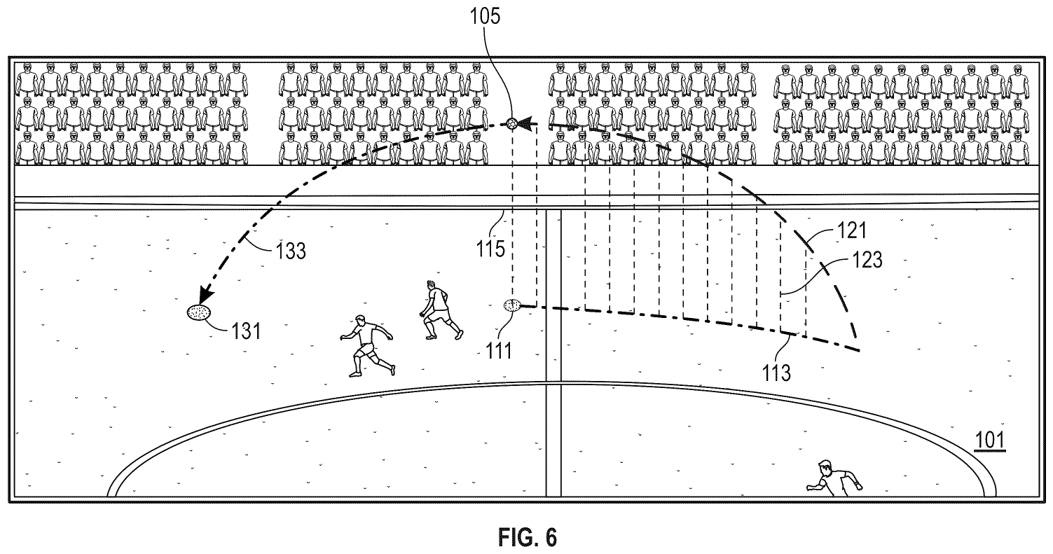

FIG. 6 illustrates the features above-noted in FIG. 1 and also shows the predicted trajectory 133 of the object 105 and its predicted landing spot 131 on the surface 101. The predicted trajectory 133 of the object 105 and its predicted landing spot 131 may be computed based on its current trajectory. For example, three points along the past trajectory and the points in time at which the object 105 was at those points may be used to calculate the speed and acceleration of the object 105 over one or more time intervals, and such data may be used to predict the remaining trajectory 133 of the object 105 and its landing spot 131. In some embodiments, a vector representing the motion of the ball may be computed, representing the velocity and direction object 105 is traveling. In some embodiments, the vector may represent a distance between locations of the object over time. In some embodiments, one or more machine learning models may be used to predict the trajectory of a ball, e.g., trained on historical data for the relevant sport, such as, for example, for a similar airborne ball from a goalie punt.

In an embodiment, one or more, or all, visual elements may be adjusted based on external factors such as ambient light or based on various other factors. The system may contextually adjust the visibility and organization of the graphics, for example, change the size, change the color, change in opacity, change in style. The system may also provide audible characteristic (for example, make a noise when the graphic becomes visible).

FIG. 7 illustrates an example of an implementation of the system 799 via computing devices 700/701, including some components thereof. A circuit board may include control circuitry, processing circuitry, and storage (e.g., RAM, ROM, hard disk, removable disk, etc.). In some embodiments, the circuit board may include an input/output (I/O) path for communicating with remote devices. Each device 700/701 may receive content and data via I/O path 702 that may comprise I/O circuitry (e.g., network card, or wireless transceiver). I/O path 702 may communicate over a local area network (LAN) or wide area network (WAN), for example, via Wi-Fi, Bluetooth, cellular or other wireless or wired connection.

Control circuitry may comprise processing circuitry 706 and storage 708 and may comprise I/O circuitry. Control circuitry may be used to send and receive commands, requests, and other suitable data using I/O path, which may comprise I/O circuitry (sometimes referred to as communication circuitry), for example, for interacting with physical devices and remote devices. I/O path may connect control circuitry (and specifically processing circuitry) to one or more communications paths (described below). I/O functions may be provided by one or more of these communications paths, but are sometimes shown as a single path to avoid overcomplicating the drawing.

Control circuitry may be based on any suitable control circuitry such as processing circuitry 706. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry executes instructions for various functions and applications, including the determination of object positions and trajectories and the generation of graphical elements and their insertion in video data, and their storing in memory (e.g., storage 708). In some implementations, processing or actions performed by control circuitry may be based on instructions received from external devices.

In client/server-based embodiments, control circuitry 704 may include communications circuitry suitable for communicating with other networks. Functionality herein discussed may be implemented as software or as a set of executable instructions. The instructions for performing any of the embodiments discussed herein may be encoded on non-transitory computer-readable media (e.g., a hard drive, random-access memory on a DRAM integrated circuit, read-only memory etc.). For example, the instructions may be stored in storage, and executed by control circuitry of a device 700.

In some embodiments, the functionality discussed herein, or aspects thereof, may be provided by a client residing on device 700, and a server application may reside on the computing device. Control circuitry may include communications circuitry suitable for communicating with a server, and devices, a table or database server, or other networks or servers. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry. As referred to herein, the phrase “electronic storage device” or “storage device” should be understood to mean any device for storing electronic data, computer software, or firmware, such as random-access memory, read-only memory, hard drives, optical drives, digital video recorders, solid state devices, quantum storage devices, gaming consoles, or any other suitable fixed or removable storage devices, and/or any combination of the same. Storage 708 may be used to store various types of content described herein. Nonvolatile memory may also be used (e.g., to launch a boot-up routine and other instructions).

Control circuitry 708 may include video generating circuitry and tuning circuitry. Control circuitry may also include scaler circuitry for upconverting and down converting content into the preferred output format of equipment 700. Control circuitry may also include digital-to-analog converter circuitry and analog-to-digital converter circuitry for converting between digital and analog signals. Video cameras may be integrated with the equipment or externally connected. One or more of cameras may be a digital camera comprising a charge-coupled device (CCD) and/or a complementary metal-oxide semiconductor (CMOS) image sensor. In some embodiments, one or more of cameras 756 may be directed at an outside physical environment (e.g., two cameras may be pointed out to capture to parallax views of the physical environment).

The system may be implemented using any suitable architecture. For example, it may be a stand-alone application wholly-implemented on each one of user equipment device 700 and user equipment device 701. In such an approach, instructions of the application may be stored locally (e.g., in storage 708), and data for use by the application is downloaded on a periodic basis (e.g., from the edge service network, from an out-of-band feed, from an Internet resource, or using another suitable approach). Control circuitry may retrieve instructions of the application from storage 708 and process the instructions to provide functionality and perform any of the actions discussed herein. Based on the processed instructions, control circuitry may determine what action to perform when input is received from user input interface 710. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, applications to provide functionality discussed may be downloaded and interpreted or otherwise run by an interpreter or virtual machine (run by the control circuitry). In some embodiments, software may be encoded in the ETV Binary Interchange Format (EBIF), received by control circuitry as part of a suitable feed, and interpreted by a user agent running on control circuitry. In some embodiments, software may be defined by a series of JAVA-based files that are received and run by a local virtual machine or other suitable middleware executed by control circuitry.

Although communications paths are not always drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network.

FIG. 8 is a diagram of an illustrative system 800 for object tracking, graphic generation and insertion and/or camera perspective selection, in accordance with some embodiments of this disclosure. User equipment devices 807, 808, 810 (e.g., which may correspond to one or more of computing device 816 may be coupled to communication network 806. Communication network 806 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 806) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 806.

System 800 may comprise media content source 802, such as one or more cameras, sensor data source 821, such as one or more UWBs and/or IMUs, one or more servers 804, and one or more edge computing devices 816 (e.g., included as part of an edge computing system, such as, for example, managed by mobile operator). In some embodiments, object 105 tracking, trajectory computation and prediction, shadow position determination, graphics generation, camera angle selection, physical and/or virtual camera positioning, and the like, may be executed at one or more of control circuitry 811 of server 804 (and/or control circuitry of user equipment devices 807, 808, 810 and/or control circuitry 818 of edge computing device 816). In some embodiments, memory 708 of FIG. 7, may be stored at database 805 maintained at or otherwise associated with server 804, and/or at storage 822.

In some embodiments, server 804 may include control circuitry 811 and storage 814 (e.g., RAM, ROM, Hard Disk, Removable Disk, etc.). Storage 814 may store one or more databases. Server 804 may also include an input/output path 812. I/O path 812 may provide graphic generation data, object position and trajectory information, camera angle data, or other data, over a local area network (LAN) or wide area network (WAN), and/or other content and data to control circuitry 811, which may include processing circuitry, and storage 814. Control circuitry 811 may be used to send and receive commands, requests, and other suitable data using I/O path 812, which may comprise I/O circuitry. I/O path 812 may connect control circuitry 811 (and specifically processing circuitry) to one or more communications paths.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i9 processors) or multiple different processors (e.g., an Intel Core i7 processor and an Intel Core i9 processor). In some embodiments, control circuitry 811 executes instructions for an emulation system application stored in memory (e.g., the storage 814). Memory may be an electronic storage device provided as storage 814 that is part of control circuitry 811.

Edge computing device 816 may comprise control circuitry 818, I/O path 820 and storage 822, which may be implemented in a similar manner as control circuitry 811, I/O path 812 and storage 814, respectively of server 804. Edge computing device 816 may be configured to be in communication with video server 804 over communication network 806, and may be configured to perform processing tasks (e.g., virtual camera video data generation, camera angle selection, graphic location computation and insertion) in connection with ongoing processing of video data. In some embodiments, a plurality of edge computing devices 816 may be strategically located at various geographic locations, and may be mobile edge computing devices configured to provide processing support for cameras and sensors, such as UWB, IMU sensors, at other spots in, around, below or above the surface 101.

In an embodiment, parallel implementation of the algorithms, with efficient algorithms and hardware acceleration, may be used so that the graphic may be overlaid in real time. A low-latency network protocol may minimize the data transmission overhead between the sensors and the processing units.

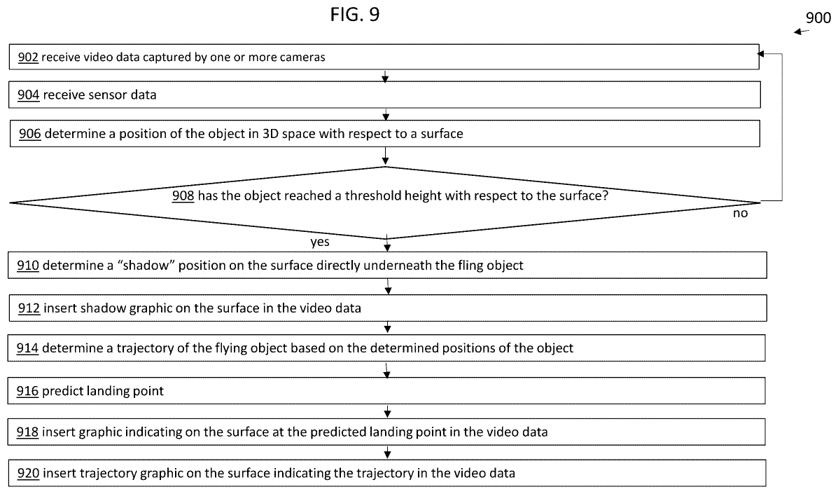

FIG. 9 is a flowchart showing an example of a process 900 for generating a airborne object's graphic on the surface beneath it, according to an aspect of the disclosure. The process 900 may be implemented, in whole or in part, by the systems shown in FIG. 7 or 8. One or more actions of the process 900 may be incorporated into or combined with one or more actions of any other process or embodiments described herein. The process 900 may be saved to a memory or storage (e.g., the storage of the system shown in FIG. 7) as one or more instructions or routines, which may be executed by any suitable device or system having access to the memory or storage to implement the process 900.

As shown in FIG. 9, at 902, the system may receive video that data captured by one or more cameras. If video feed is received from more than one camera, then a camera may be selected that shows the trajectory of the airborne object 105.

At 904, sensor data may be received, for example, from one or more UWB and/or from one or more IMU sensor inside or on the airborne object 105.

At 906, based on this sensor data alone, or based on the video data, for example, using machine vision, or based on the sensor data used in conjunction with the video data, one or more positions of the object 105 may be determined.

At 908, the system determines whether the object has reached or surpassed a threshold height. This determination may be performed before one or more of the earlier steps shown in FIG. 9 and may trigger one or more steps, 902-906 discussed herein. For machine vision-based tracking, an object detection algorithms (e.g., based on deep learning) may be used to identify the airborne object in each camera frame. The detected object may be detected across multiple camera views using feature matching or correspondence algorithms. Given the match, the system may compute the object's 3D position by triangulating the matched points from different camera views. If, at 908, it is determined that the object has not reached or surpassed the threshold height, the process reverts to 902.

If the object has reached or surpassed the threshold, then, at 910, the system may determine a graphic position on the surface 101 to be inserted, for example, on the ballfield, directly underneath the airborne object 105.

At 912, the system may insert the graphic on the surface 101 (e.g., overlaid) in the video data.

At 914, a trajectory of the airborne object 105, may be determined based on the determined positions of the object. The trajectory of the airborne object 105 may be determined earlier, for example, after the first elevated positions of the object are first detected.

At 916, based on the determined trajectory, a landing point of the object 105 on the surface 101 may be predicted. At 918, a graphic 131 shown in FIG. 6 indicating on the surface 101 the predicted landing point 131 may be inserted in the video data to indicate where on the surface 101 the object is likely to land. The graphic 131 indicating the predicted landing point may look different (e.g., may be a different color, size and/or shape) from the graphic 111 or may appear similar. In an implementation, the graphic 131 indicating the predicted landing point may be consistently larger or may be consistently smaller than the graphic 111.

A graphic indicating a trajectory of the object 105 in the air may be generated and inserted in the video data. The graphic indicating the trajectory may show the path of the object 105 until the current point in the video data and/or the predicted trajectory 133 of FIG. 6 of the object 105 until it lands at the landing site 131.

At 918, a trajectory graphic 113 indicating on the surface 101 the line on the surface 101 underneath the overhead trajectory of the airborne object 105 may be inserted. The shadow trajectory graphic indicates on the surface 101 directly underneath the actual trajectory, and/or the predicted trajectory until the landing site, the points on the surface 101 directly underneath the airborne path of the object 105.

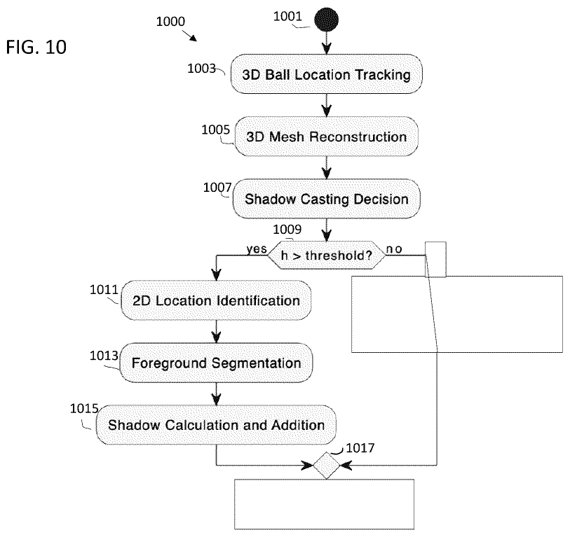

FIG. 10 is a flowchart showing an example of a process 1000 for determining an airborne object's shadow on the surface. The process 1000 may be implemented, in whole or in part, by the systems shown in FIG. 7 or 8. One or more actions of the process 1000 may be incorporated into or combined with one or more actions of any other process or embodiments described herein. The process 1000 may be saved to a memory or storage (e.g., the storage of the system shown in FIG. 7) as one or more instructions or routines, which may be executed by any suitable device or system having access to the memory or storage to implement the process 1000.

In an embodiment, the system may start at 1001 in response to detection of the object 105 more than a threshold distance above the surface 101.

In response, at 1003 the system may commence tracking the location of the object 105 in a 3D physical space above the surface 101. In an embodiment, the system may continuously track the location of the object 105 even when on or near the surface 101.

At 1005, the system may construct or reconstruct a 3D mesh of the surface 101. This may be performed at this time, or the system may prebuild a 3D mesh of the surface 101 before the object is to be tracked (e.g., before a game). This mesh may be flat (e.g., a soccer or football field) or non-flat (e.g., a golf course). Given the livestream feed from video cameras, computer vision algorithms may be used to identify the markers and match them with the 3D location within the mesh. These matches may be used to fit the projection matrix so that a mapping function may be used to establish a correspondence between the 3D world frame to the 2D video frame. Video tracking algorithms may aid in aligning the 3D mesh with video frames and in updating the projection matrix frame by frame. In an embodiment, the system may use a process that entails calibration, feature detection and matching, triangulation, and dynamic updating to ensure accuracy and real-time tracking of the object. The resulting 3D mesh may allow for visual overlay of the graphic, which may result in a system that provides visibility of the position of the airborne object. The 3D mesh may be represented as triangles as in computer graphics.

At 1007, the system may decide whether the graphic for the object 105 is to be generated and inserted into the video data feed. For example, it may be decided that the object 105 is no longer in play or that a different ball has been selected as the ball in the game.

In a related vein, at 1009 the system may determine whether the object 105 has reached a threshold minimum elevation. If not, then the system may proceed to 1017, where the process may end. As discussed, this decision may be made earlier in the process, for example, before tracking of the object 105 is started.

On the other hand, if the system decides that shadow casting is called for and that the threshold minimum elevation is reached, then at 1011 a location for the graphic on the surface 101 directly underneath the airborne object 105 may be determined.

At 1013, the system may segment the surface 101 or one or more portions thereof, such as the foreground of the surface 101 (e.g., the area of the frame closer to the camera than the object 105). Based on this, the position of the shadow is calculated and at 1015 it is inserted into frames of the video data feed. The process ends at 1017.

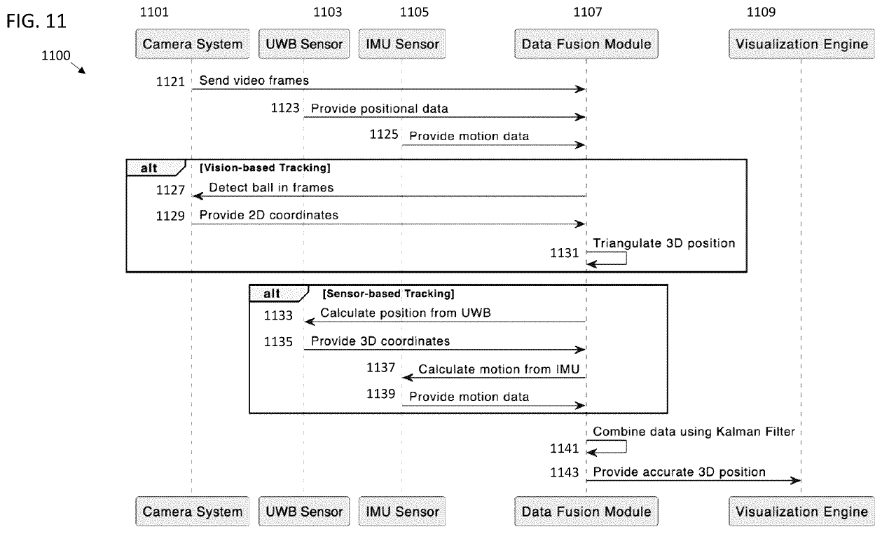

FIG. 11 is an example of a process 1100 for system communication and processing for determining a position of an airborne object 105, such as a ball, according to an embodiment of the disclosure. An aim of process 1100 is to locate the airborne object 105 in 3D space so that in further processes a position of the graphic on the surface 101 may be computed.

At 1121, a camera system 1101 that includes one or more cameras trained on the surface 101 may transmit video frames to a data fusion module 1107. In an implementation, a drone airborne above the surface or above the object 105 may track the 3D location of the object 105. In an implementation, the drone may stay above the object 105 to cast a shadow using a strong light source.

At 1123, UWB sensor(s) 1103 may transmit sensor data regarding the position of the airborne object 105 to the data fusion module 1107. Other sensors, such as one or more IMUs 1105 may also transmit sensor data regarding motion of the airborne object to the data fusion module 1107. One or more types of sensor data may be transmitted substantially contemporaneous with 1121 or prior to the transmission of the video frames, or some of the sensor data may be transmitted before, and some may be transmitted after the transmission of the video frame.

In order to fuse the data, data from cameras and sensors may be synchronized in time. For example, each data point may be timestamped so that the system may align the data points in a common timeline. A Kalman filter or an Extended Kalman Filter (EKF) may be used to combine the vision-based and sensor-based tracking data. The Kalman filter may predict the object's state (position, velocity, etc.) and update these predictions based on the measurements from both sources. The filter may use the IMU data to predict the object's next state, and correct this prediction with the vision-based triangulated position and UWB measurements. The fused data may be used to correct any errors or drift in the individual tracking methods. For example, if the vision-based system detects an occlusion, the sensor data may be used to maintain tracking accuracy. A further smoothing algorithm may be applied to the fused data to remove noise and ensure a stable and continuous tracking output.

Steps 1127-1131 describe video data-based airborne object tracking, while steps 1133-1139 describe sensor data-based airborne object tracking. Each of these processes may be performed without the other process to determine the location of the airborne object 105, or both processes may be performed. They may be performed substantially simultaneously, or one or more steps of either process may be performed before steps of the other process.

At 1127, the data fusion module 1107 may transmit a request to the camera system 1101 to detect video frames that depict the object 105 in the video data.

At 1129, the camera system may identify such frames, may determine 2D coordinates of the object 105 in the frames of the video data, and provide the coordinates to the data fusion module 1107.

Based on such 2D coordinates, at 1131 the data fusion module 1107 may compute 3D coordinates of the object 105 by triangulating the 2D coordinates in multiple video frames. 2D coordinates identified from frames captured by more than one camera may be used in the triangulation.

In an embodiment, based on the 3D location of the object, the system may identify the projected 2D location on the surface 101, and use a strong spot light or a laser projection to cast a light spot on the surface 101. A motion control system may be used to track in real time the location and to cast the light or laser.

At 1133, the data fusion module 107 may transmit a request to a UWB sensor to provide position data of the object 105.

At 1135, the UWB sensor may provide 3D coordinates to the data fusion module 1107.

At 1137, the data fusion module 107 may transmit a request to an IMU sensor to provide motion data of the object 105.

At 1139, the IMU sensor may provide motion data to the data fusion module 1107.

At 1141, the data fusion module 107 may combine the data received, for example, using a Kalman Filter.

At 1143, the data fusion module 107 may pass the 3D position, and may also pass the 3D motion data, to the visualization engine 1109.

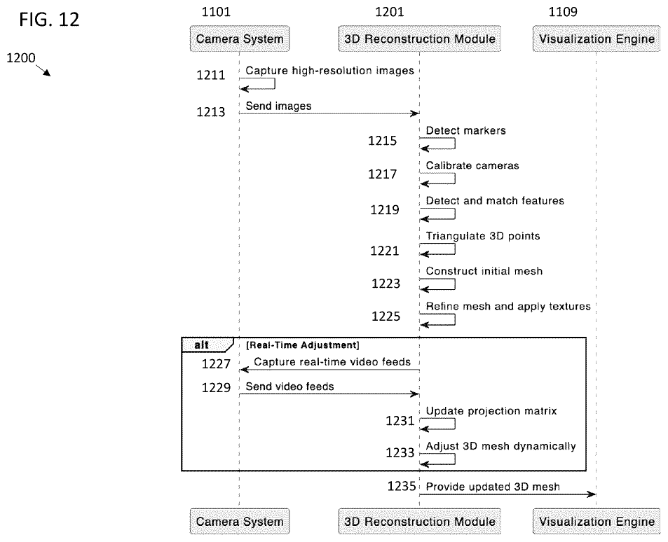

FIG. 12 is an example of a process 1200 for system communication and processing for determining a 3D surface, according to an embodiment of the disclosure. An aim of process 1200 is to locate the surface 101 in the same 3D space as the airborne object 105 by creating a fine mesh of points representing the surface 101.

At 1211, the camera system 1101 captures images (e.g., high resolution video frames) of the surface 101.

At 1213, these images are transmitted to a 3D reconstruction module 1201.

Starting 1215, the 3D reconstruction module performs a series of operations based on the image data received: at 1215 the 3D reconstruction module detects markers in the field which may be a collection of points, visible or indiscernible to the naked eye, that may be used in further processing to mark off locations.

At 1217, the camera may be calibrated as discussed above.

At 1219, the system may detect and match features of the surface 101 with the points collected.

At 1221, the system may triangulate the 3D points, as explained elsewhere herein.

At 1223, the system constructs an initial mesh. For non-flat terrain, such as a golf course, topographical data may be obtained in advance to provide a starting point for the 3D mesh reconstruction and to calibrate the position of the cameras and the object to be tracked. In an embodiment, as part of the machine vision approach, feature detection algorithms, such as scale-invariant feature transform (SIFT)—computer vision algorithm to detect, describe, and match local features in images, and/or speeded up robust features (SURF) techniques may be used to identify distinct points in each image. These features may be matched across different camera views to establish correspondences. For golf courses and other uneven terrain, features often include significant terrain changes. The matched features may be triangulated to compute their 3D coordinates, which may involve solving the geometric relationship between corresponding points from different camera views. The system may use the triangulated points to construct an initial 3D mesh of the terrain. For golf courses, this mesh may represent hills, valleys, and flat areas. Further, surface reconstruction algorithms (e.g., Poisson Surface Reconstruction) may be applied to refine the initial mesh.

At 1225, the 3D reconstruction module 1201 may refine the mesh and apply textures.

Steps 1227-1233 are a series of operations for real-time adjustment. At 1227, the 3D reconstruction module 1201 may request that the camera system 1101 capture real-time video feeds.

In response, at 1229, based on video from one or more cameras, the video system 1129 may send back video feed(s) to the 3D reconstruction module 1201.

At 1231, the video feed received may be used by the 3D mesh reconstruction module 1201 to update the projection matrix.

At 1233, the 3D mesh reconstruction module 1201 may update or adjust dynamically the 3D mesh. The updated mesh may then be provided by the 3D mesh reconstruction module 1201 to visualization engine 1109.

In an embodiment, the mesh may capture fine details and smooth transitions to dynamically adjust the 3D mesh based on real-time video feeds. For example, if new terrain features are detected, the mesh may be updated accordingly. The system may match the real-time video feed with the 3D surface models, and this matching may be used to continuously update the projection matrix to maintain accurate mapping between the 3D mesh and the 2D video frames. In an embodiment, the mesh may represent fine details and smooth transitions, trying to dynamically adjust the 3D mesh based on real-time video feeds. For example, if new terrain features are detected, the mesh may be updated accordingly. The real-time video feed may thus be matched with the 3D surface models, and the matching may be used to continuously update the projection matrix to maintain accurate mapping between the 3D mesh and the 2D video frames.

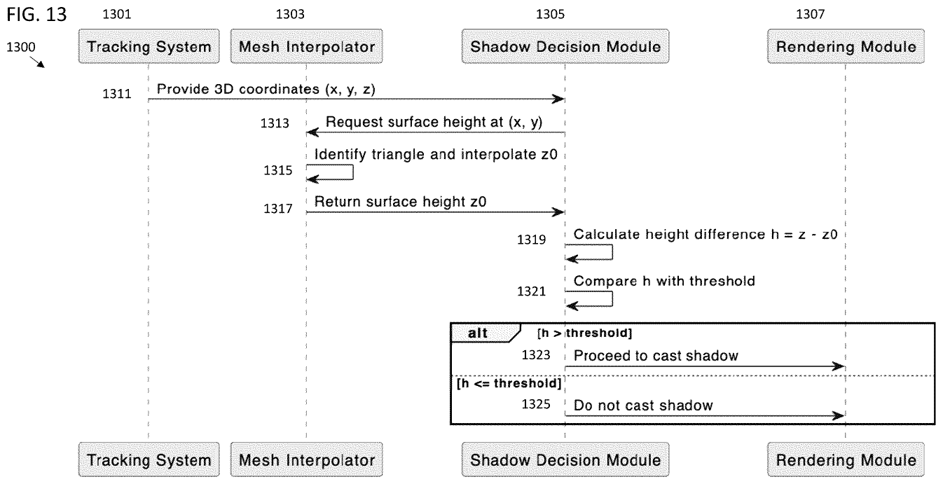

FIG. 13 is an example of a process 1300 for system communication and processing for determining whether to generate a graphic, according to an embodiment of the disclosure. An aim of this process 1300 is to determine whether the airborne object is at least a threshold distance higher than the surface.

At 1311, tracking system 1301 transmits the 3D coordinates of the airborne object 105 to a shadow decision module 1305. It will be understood that these other module and units may be part implemented as one or more software modules or hardware units of the same computing device or group of computing devices. For example, in view of the 3D location (x, y, z) of the object 105 and the surface height, which may be determined by interpolating the z0 based on x,y and the triangle meshes, we can obtain a height information of h=z−z0. The system may then determine whether a graphic 111 needs to be cast based on the object's height h. If the object is above a certain threshold (e.g., 2 m, or 02.-10 for a soccer ball), the system may decide to generate the graphic 111.

In response, the shadow decision module 1305 may request from mesh interpolator 1315 a height of the surface 101. This may be particularly necessary with uneven surfaces, such as golf courses.

At 1315, the mesh interpolator may identify, triangulate and interpolate coordinates along the Z-axis.

At 1317, the mesh interpolator 1317 transmits a surface height, which may be expressed as Z origin, to the shadow decision module 1305.

At 1319, the shadow decision module 1305 may calculate a height difference between the coordinates of the airborne object 105 (Z-axis value) and the surface height (Z origin).

At 1321, this height difference may be compared with the threshold height difference h. If the height difference is equal to or exceeds the threshold height difference h, then the process proceeds to 1323.

Then at 1323, the shadow decision module 1305 may request rendering module 1307 to generate the graphic 111. On the other hand, if the height difference does not equal or exceed the threshold height difference h, then at 1325, the shadow decision module 1305 may request rendering module 1307 not to generate the shadow effect, or the shadow decision module 1305 may stop processing without communicating with the rendering module 1307 to request the generating of the graphic 111.

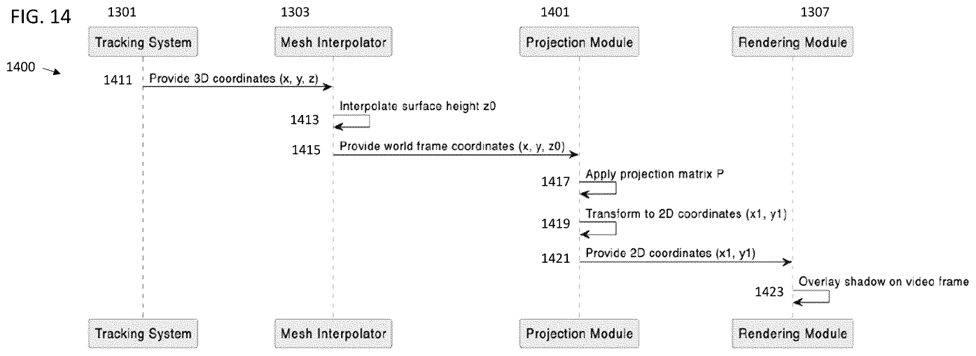

FIG. 14 is an example of a process 1400 for system communication and processing for graphic generation, according to an embodiment of the disclosure. An aim of process 1400 is to determine a location for the graphic 111 on the surface 101 and to insert the graphic 111 at the correct location on the surface 101 directly underneath the airborne object 105. The system may need to identify the 2D location within the video frame where the graphic 111 will be inserted. This determination may be based on the mesh representation of the surface 101 and the x, y coordinates representing the location in 3D of the airborne object 105. The graphic 111 location in the world frame should be (x, y, z0) and using the projection matrix, its location may be (x1, y1) in 2D video frame.

At 1411, the tracking system 1301 may transmit coordinates in 3D space (e.g., along the X, Y and Z axes) of the airborne object 105 to the mesh interpolator 1303.

At 1413, the mesh interpolator interpolates surface height (e.g., z=zero).

At 1415 the world frame coordinates in 3D space are sent by the mesh interpolator 1303 to a projection module 1401.

At 1417, the projection module may apply a projection matrix P.

At 1419, the projection module 1401 may transform the coordinates to 2D coordinates (e.g., x1, y1). These 2D coordinates may be then relayed at 1421 to the rendering module 1307, which at 1423 may overlay the graphic 111 on one or more video frames.

In an implementation, the shadow can be shown as a heatmap or color gradient on the surface 101 that dynamically changes based on the object's location. Thus, the area directly under the object 101 may glow or change color, indicating the location. In an augmented reality (AR) or extended reality (XR) implementation, an onsite AR device (e.g., a head mounted device) may display the graphic 111 of the object 105 on the surface 101, and/or the object's path on surface 101.

In an implementation, these processes need not be performed in response to detection of each new position of the airborne object 105 as it moves through its trajectory. According to this implementation, successive positions for the graphic 111 may be computed from previous positions of the graphic 111 once the trajectory of the airborne object 105 has been determined. The second graphic 113, which indicates a trace on the surface 101 of the actual trajectory in the air of the airborne object 105, may also be computed in this way.

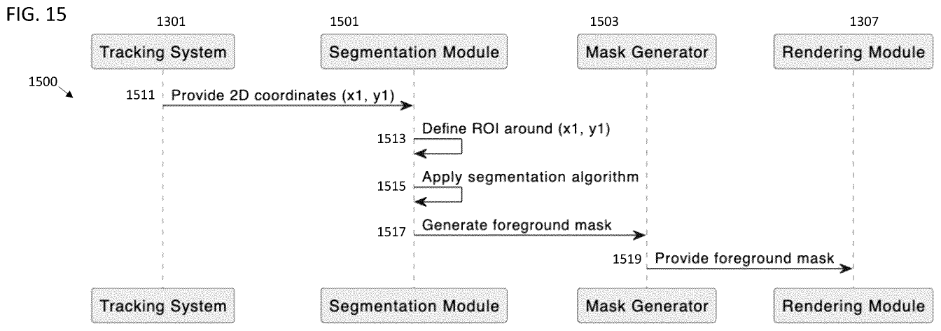

FIG. 15 is an example of a process 1500 for system communication and processing for determining foreground segmentation, according to an embodiment of the disclosure. An aim of this process 1500 is to segment a foreground to remove nearby objects (e.g., ball players) before inserting the graphic 111 at the surface 101. The graphic 111 may be cast directly on the ground and may avoid objects (e.g., players on the field) in the video frame. The segmentation algorithm may create a mask of the foreground objects in the vicinity of the location of the graphic 111. In an embodiment, the segmentation task may be performed for the entire frame. In an embodiment, the segmentation task may be performed for each frame no matter whether the shadow casting is needed, for example, when it is implemented in hardware.

At 1511, tracking system 1301 may provide 2D coordinates (e.g., x1, y1) to a segmentation module 1501.

Based at least in part on this information, at 1513 the segmentation module 1501 may define a region of interest (ROI) around the 2D coordinates received. The size of the region of interest may be driven by the type and size of the graphic 111 to be inserted. A larger ROI may be necessitated by a larger graphic 111 to be inserted.

At 1515, the segmentation module 1501 may apply a segmentation algorithm for the ROI.

At 1517, the segmentation module 1501 may then transmit a foreground mask request to mask generator 1503, which may generate the foreground mask.

At 1519, the mask generator 1503 may transmit it to rendering module 1307.

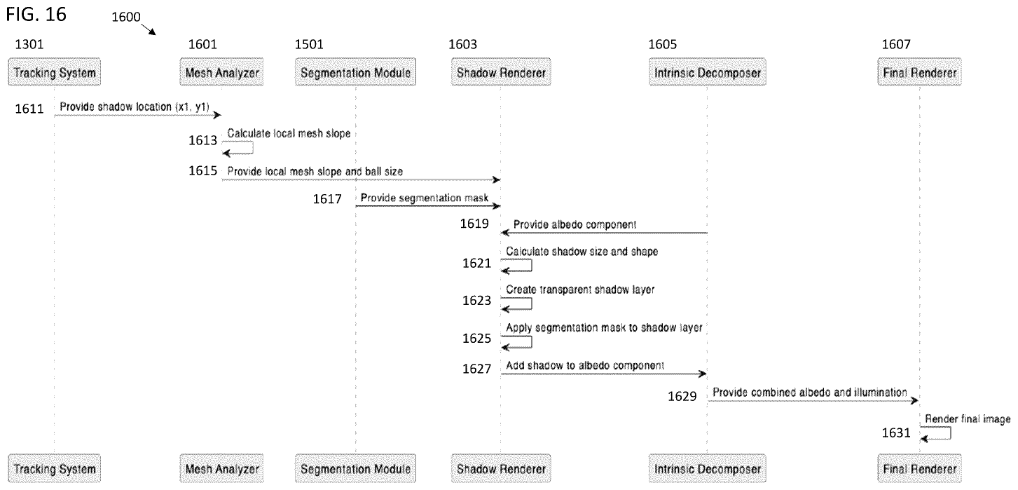

FIG. 16 is an example of a process 1600 for system communication and processing for graphic generation, according to an embodiment of the disclosure. An aim of this process 1600 is generate and render the graphic 111 at the surface 101. Once the graphic location is determined, an appropriate size and shape of the graphic may be determined based on the local mesh slope, the object size, and distance from the camera. The system may further decompose the ground surface into albedo and illumination using intrinsic image decomposition. After that, the system may add the graphic 111 as a transparent layer with certain transparency value (e.g., 50%) onto the albedo component. In an embodiment, to ensure that the graphic respects the segmentation mask (i.e., is added only to the areas outside of the segmentation mask, which masks out the foreground players and objects). The final image may then be rendered with the illumination layer of the decomposition.

At 1611, tracking system 1301 may provide the coordinates of the location of the graphic 111 to be inserted into one or more video frames to mesh analyzer 1601.

At 1613, the mesh analyzer 1601 may calculate the slope of the mesh representing the surface 101.

At 1615, this mesh slope and a size of the airborne object 105 may be communicated to a shadow renderer 1603. In an implementation, the size and/or shape of the airborne object 101 may drive the size and/or shape of the graphic 111. For example, if the airborne object 105 is a substantially spherical ball then the graphic 111 may be generated on the surface to have the appearance of a circle or substantially a circle. If the airborne object 105 is an American football (“pigskin”) then the graphic 111 may be generated to have a prolate spheroid shape. In an implementation, the size of the graphic 111 may be substantially the same (e.g., of approximately the same number of pixels of a video frame) as the airborne object 105. In an implementation, the size of the graphic 111 may be constant throughout a trajectory of the airborne object 105, or the size of the graphic 111 may be constant in every trajectory of the airborne object 105, regardless of how large the airborne object 105 appears in the video frame.

At 1617, the segmentation module 1501 may provide a segmentation mask to a shadow renderer 1603.

At 1619, an intrinsic decomposer may provide an albedo component to the shadow renderer. In some embodiments, intrinsic decomposition may separate an image into two components, albedo and shading. Albedo may represent the intrinsic color/texture of the surface, while shading may capture the illumination effects. Therefore, when we try to add something to the surface, the system may first modify the albedo, which allows the system to change the inherent color/texture of the surface. Then, the system may re-render it with the original illumination. In this way, the edited surface may look more photorealistic. In an implementation, the color and/or transparency of the graphic 111 may be based at least in part on how reflective or bright the airborne object 105 is.

Based at least in part on this information, the shadow renderer 1603, at 1621, may calculate the size and/or shape of the graphic 111.

At 1623, the shadow renderer 1603 may generate a transparent shadow layer.

Then, at 1625, the shadow renderer 1603 may apply the segmentation mask to the shadow layer. As discussed, applying the segmentation mask may be necessary to prevent obscuring with objects in the ROI.

At 1627, the shadow renderer 1603 may add the graphic to the albedo component and transmit these, at 1627, to the intrinsic decomposer 1605.

The intrinsic decomposer 1605 may, at 1629, provide the combined albedo and illumination data to a final renderer 1607.

At 1631, based on this data, the final renderer 1607 may then render the final image for the video frame.

The video frames with the added shadow may then be compressed for live streaming or broadcasting. In an embodiment, the parameters of the graphic may be embedded as metadata so that it can be rendered at the TV side.

In an embodiment, the original video data may be compressed as a base layer and an additional enhancement layer may be added to show the shadow in the image. The viewer may have the capability to toggle on and off this visualization of the graphic 111. In a similar vein, the viewer may have the capability to toggle on and off visualization of the other graphics discussed herein, such as the second graphic 113 showing on the surface 101 the trace of the overhead actual trajectory 121, and/or the actual trajectory graphic overhead 121, and/or the landing spot graphic 131, and/or the remaining overhead trajectory graphic 133 together with the graphic 111, or as a separate toggle for each graphic. For live broadcasting, the operator may have the option to switch between whether and when to broadcast the graphic 111 and any of the other graphics discussed herein, as added video or the original video. In some embodiment, the video may be coded in a way that the enhancement layer contains the graphic, and the user watching the broadcasting may have the option to switch on and off the graphics.

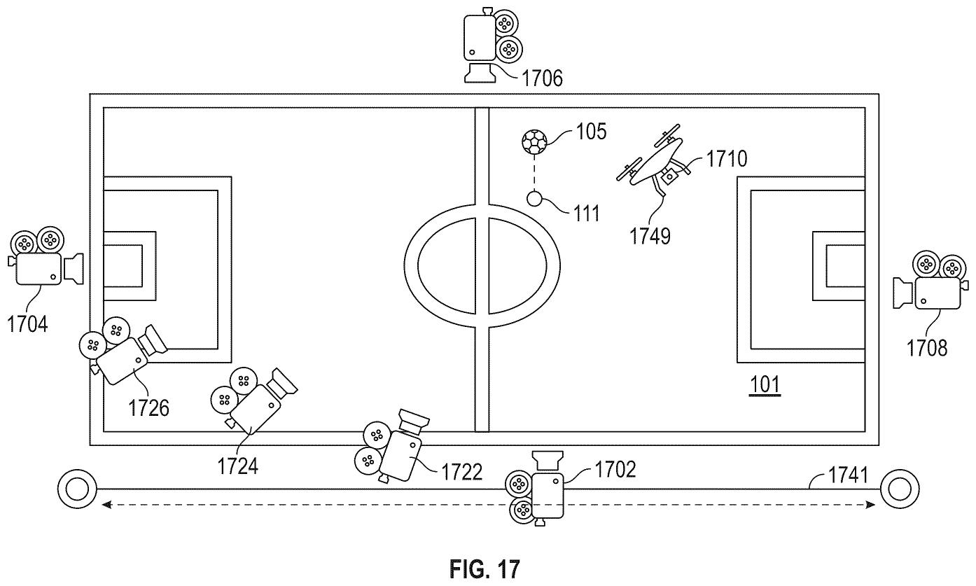

FIG. 17 shows video camera 1702, 1704, 1706, 1708 located around a soccer field 101, which is the surface over which the airborne object 105, represented in this example as a soccer ball, is airborne. The graphic 111 is shown rendered on the surface 101 directly under the object. Also shown is an airborne drone 1749 airborne over the soccer field with a further video camera 1710.

An embodiment for determining a new camera perspective and new camera, to be used to capture an object (e.g., airborne object 105), will be described with respect to FIGS. 17-20.

To facilitate viewer perception of the 3D location of the airborne object 105, the system may dynamically adjust a camera angle of a camera being used to capture an object. This may involve transitioning from an initial camera perspective to a target camera perspective showing clearly one or more positions at which the airborne object 105 is airborne and then returning the video feed to the original camera or to the original camera perspective when the object 105 returns to the ground. This target perspective may be one of the existing physical camera positions and angles, or the target camera perspective may be a position and/or angle to which the original camera or another physical camera is controlled to move. In an embodiment, the target camera perspective may be a perspective of a virtual camera based on the video data of two or more physical cameras.

FIG. 17 also shows virtual cameras 1708, 172,4, and 172,6 located between physical camera 1702 and physical camera 1704. The video data of virtual cameras 1708, 172,4 and 172,6 may be interpolated based on the image data captured by physical camera 1702 and physical camera 1704 and/or any other suitable physical camera.

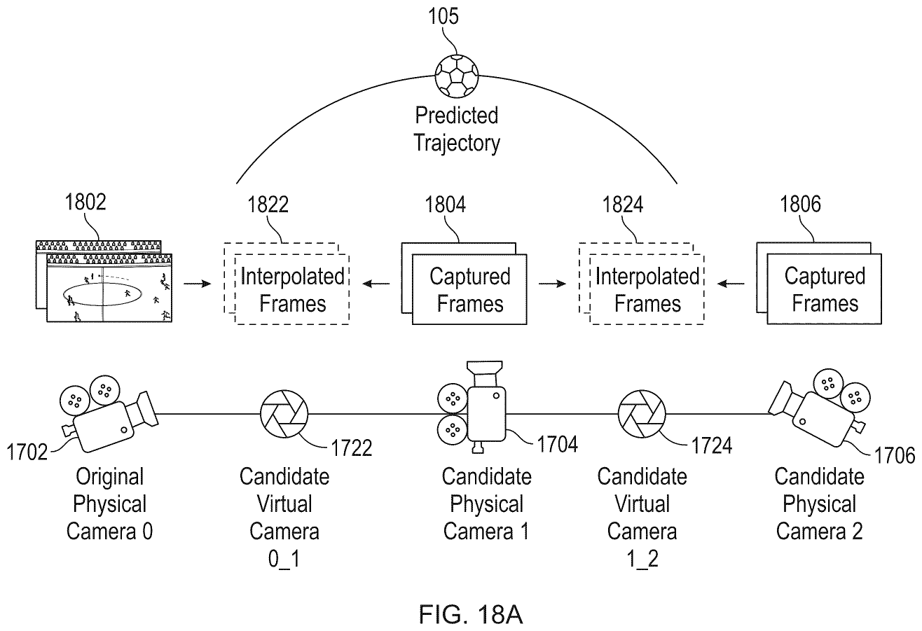

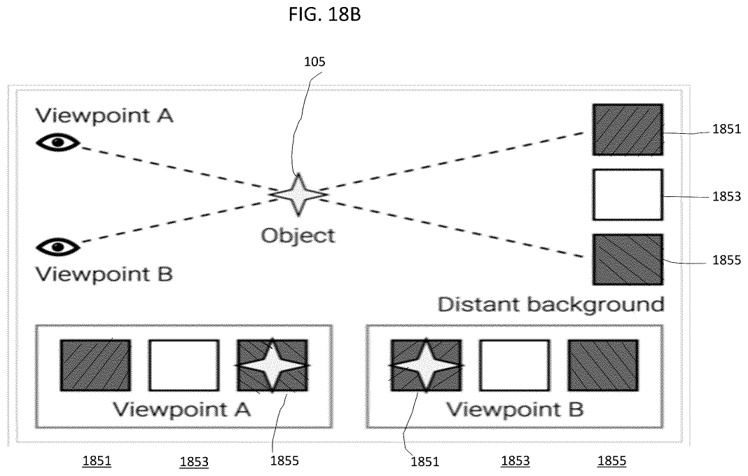

FIG. 18A shows that Camera 0 (1702) is capturing video data of the object 105 from a first vantage point. By predicting the airborne object's trajectory and landing time, the system may transition from the original camera perspective to a new, target camera perspective, as follows: predict the trajectory and landing time of the airborne object 105; identify a target camera perspective for viewing the airborne object 105; transition the video feed from the original camera to the target camera; and return the receiving of the video feed from the target camera to the original camera perspective of Camera 0 (1702) while the airborne object 105 is landing.

As shown in the example provided in FIG. 18A, first video data 1802 captured by physical camera 0 (1702) and second video data 1804 captured by physical camera 1 (1704) may be interpolated to generate interpolated frames 1822 ascribed to virtual camera 0_1 (1708). The first physical camera 0 (1702) may be suspended from a wire 1741 of FIG. 17 to facilitate rapid and steady movement of the first physical camera 0 (1702) along a side of the field 101. Similarly, second video data 1804 captured by physical camera 1 (1704) and third video data 1806 captured by physical camera 2 (1706) may be interpolated to generate interpolated frames 1824 ascribed to virtual camera 1_2 (172,4).

Trajectory prediction may entail using real-time 3D coordinates (x, y, z) of the airborne object 105 obtained from the tracking system to predict its trajectory. Landing time estimation may be calculated by estimating a time when the object 105 will land using physics-based models that consider the object's current velocity, acceleration, and environmental factors.

A target perspective may include a camera's position and orientation (or angle) toward the object 105 and/or the trajectory of the object 105. The target perspective may be selected by quantifying camera perspectives based on a variety of factors, including depth perception, occlusion, and field of view. A possible objective function could be:

$$Objective = α \cdot DP + β \cdot MP + γ \cdot FOV - δ \cdot OCC \qquad ( 1 )$$

where:
DP is the depth perception measure which measures how well the angle allows the viewer to perceive depth. In an embodiment, the DP is based on the apparent size of the object 105 in the camera view and the z-depth range visible from the camera perspective. Larger size of the object 105 and larger range may provide better depth perception.
MP is a measure of the apparent motion of objects as the view point changes.
FOV is a field of view coverage measuring how well the camera perspective covers the area of interest, and
OCC is the measure of how much the object is obscured by other objects.
   The weights α, β, γ, δ may be used to balance the importance of each of these four factors. Sometimes, a weighting coefficient may be zero. Additional factors may also be computed and taken into consideration in computing the target camera perspective.

DP may be calculated based on how big the object appears in one or more video frames. In an embodiment, DP may be calculated as the number of pixels that depict the object 105 in a standardized video frame. This may be directly related to the distance between the object and the camera. In an embodiment, the system may calculate a normalized version with range [0, 1]. Thus, for example, the system may measure DP1=0.5 and DP2=0.2 because camera 2 is farther away so the object appears to be smaller in camera 2.

In an embodiment, the MP is calculated by simulating small camera movement, i.e., a simulated slight moving of the camera orientation or camera position to observe the relative motion of the object 105 and the background objects. The bigger the relative motion between the object 105 and the background, the greater the motion parallax effect for the camera perspective.

In some implementations, the parallax effect may be quantified as the shift of the object's location in the image, when the camera angle/position is shifted a certain small amount. For instance, if the camera shifts towards the left 1 mm, the system may calculate how many pixels the object shift to the right.

In some implementations, the parallax effect may be measured with respect to apparent offset of background objects from a direct line of sight of a given camera. For example, as shown in FIG. 18B, the 3D coordinates for airborne object 105 and of background objects 1851, 1853, 1855 (e.g., the background objects could be fans in the stadium or features of the stadium structure) may be known. If the camera perspective is moved, for example, by simulated movement, from viewpoint A to viewpoint B while keeping the airborne object 105 centered in the field of view, the angle from the camera PoV line of sight stays roughly the same (e.g., 0 degrees) to the airborne object 105. But the observed position of background object 1855 changes right (e.g., from 0 degrees to, for example, 20 degrees) of the line of sight. Thus, according to such implementations, the measured parallax effect may be expressed as 20 degrees. Thus, the relative change in the apparent positions of background objects in response to a change in the line of sight of the camera to the object 105 (e.g., the object 105 moved 0 degrees relative to the camera PoV/line of sight, and the background object 1855 moved 20 degrees right of the line of sight, resulting in a difference of 20 degrees when subtracting any intervening motion of the object 105). MP may be calculated based on simulating a small change in camera angle and observing how much the object 105 moves in the image. Or, MP may be calculated by simulating a slight movement of the object 105, and observing how much the object 105 moves in the image plane of the camera. In addition, MP may be calculated by simulating a slight movement of the camera and a slight movement of the object 105.

In this example, the system may measure:

$$MP 1 = 0.8 and MP 2 = 0.3 ,$$

as a movement of object 105 along its trajectory will move more on the image plane of the camera 1, while it moves much less on the image plane of the camera 2.

In an embodiment, the FOV coverage may be calculated by how much the trajectory of the object 105 is captured in the field of view of the camera. A camera perspective that has a field of view that encompasses most or all of the trajectory of the object 105 may be scored higher than a camera perspective with a FOV that captures little of the trajectory of the object 105.

In this example, the system may use the one location of the object 105 (e.g., at or near the zenith of its trajectory) to evaluate FOV, however FOV may be evaluated with the entire trajectory of the airborne object 105. In this example, the system may determine that FOV of camera 0 (1702) is greater, and therefore assume that FOV of camera 0 (1702)=0.4, and FOV of camera 1 (1704)=0.1

In an embodiment, the OCC entails a visibility check to determine a percentage of the trajectory of the object 105 in which the object 105 is occluded by other objects in the scene. In the example, illustrated in FIG. 18, there is no occlusion for any camera perspective, so OCC1=OCC2=0.

In an embodiment, one or more of these factors DP, MP, FOV and OCC may be determined at the time the object 105 is first determined to be airborne or at the time the object 105 is first determined to have a passed a threshold height, for example, 1-3 m or 0.2-50 m. In an embodiment, one or more of these four factors may be determined at the time the object 105 is at the apex of its trajectory. In an embodiment, one or more of these factors may be determined for an average of positions of the object 105 in the course of its trajectory. One or more of these factors may be estimated for future positions of the object 105 and then the estimate of the one or more of these factors may be used to determine the target camera perspective and the target camera for capturing the trajectory of the object 105.

A similar series of determinations may be performed for the video data captured at each camera perspective, or interpolated for each virtual camera perspective. For each candidate camera perspective, the above-noted function may be evaluated as follows. Assuming α=1, β=0.8, γ=0.5, δ=0.2:

$$Camera O 1 = 1 * 0.5 + 0.8 * 0.8 + 0.5 * 0.4 + 0 = 0.89$$

$$O 2 = 1 * 0.2 + 0.8 * 0.3 + 0.5 * 0.1 + 0 = 0.31$$

The system may choose camera 1 because O1>O2.

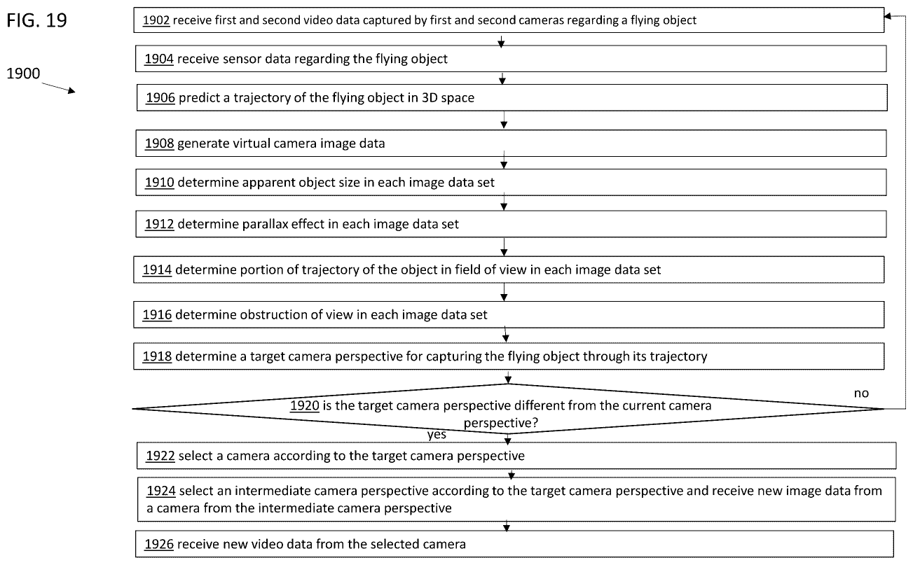

FIG. 19 is a flowchart showing an example of a process 1900 for choosing a new camera, according to an aspect of the disclosure. The process 1900 may be implemented, in whole or in part, by the systems shown in FIG. 7 or 8. One or more actions of the process 1900 may be incorporated into or combined with one or more actions of any other process or embodiments described herein. The process 1900 may be saved to a memory or storage (e.g., the storage of the system shown in FIG. 7) as one or more instructions or routines, which may be executed by any suitable device or system having access to the memory or storage to implement the process 1900.

As shown in FIG. 19, at 1902, the system may receive first video data and second video data captured, respectively, by a first video camera and a second video camera. In some situations, such as a ballgame, there may be additional video cameras providing additional video data. It may be possible that the target camera perspective eventually selected may be a camera that at the current moment contains little or no depiction of the airborne object 105, yet ends up being a camera perspective that shows well most of the trajectory of the airborne object 105.

A position of the airborne object 105 in 3D space may be determined in a variety of ways. At 1904 sensor data, for example, IMU sensor data and/or UWB sensor data may be received. As discussed with respect to the graphic embodiment, machine vision techniques may be used to determine the position of the object 105 and/or the combination of sensor data and the video data captured by the cameras may be used to determine the position of the object 105. At 1906, the position of the airborne object 105 is determined in 3D space.

At 1908, a trajectory of the airborne object may be predicted in the 3D space. Successive position data alone may be used to determine the position, direction, speed and acceleration of the object 105 and thus its trajectory. The trajectory may be predicted for either or both: (i) the trajectory of the object 105 until the moment in time the determination is made, and (ii) for the future trajectory of the object 105 until its landing position at the surface 101, or for a portion of one or more of the foregoing.

Starting at 1910, a series of operations may be undertaken to determine factors (DP, MP, FOV, OCC) discussed in the foregoing discussion that may go into the determination of the target camera perspective. At 1910, an apparent object size in each image data set may be determined.

At 1912, a parallax effect (MP) may be determined for each image data set. For each image data set, the parallax effect may be determined for multiple points along the trajectory of the object 105. In an implementation, one or more virtual cameras may be used to predict the parallax effect for the camera perspective for a future point in the predicted trajectory of the object 105. For example, video data interpolated according to such a virtual camera perspective may indicate that at a future point along the trajectory of the object 105, a current physical camera perspective may provide an advantageous parallax effect for depicting the position of the object 105. Similarly, one or more virtual cameras may be used to predict the DP and/or the FOV and/or the OCC for the camera perspective for a current or for a future point in the predicted trajectory of the object 105.

At 1914, one or more portions of the trajectory, or all of the trajectory, of the object 105 in the field of view (FOV), may be determined for each image data set.

At 1916, one or more obstructions (OCC), if any, in the field of view may be determined for each image data set. In an implementation, the system may determine, based on a current position of the object 105 and/or based on the predicted trajectory of the object 105, obstructions that block a view of the object 105. In such an implementation, obstructions that do not block, or are not predicted to block, a view of the object 105 may be removed from further consideration.

At 1918, a target physical camera perspective may be determined for capturing the object 105 along its predicted trajectory.

At 1920, the system may determine whether the target camera perspective that has been determined at 1918 is different from the perspective of the current camera—the camera that is currently providing video data for streaming or broadcasting. If not, then processing may return to 1902 because no further action may be required to obtain a new camera perspective.

If a target camera perspective different from the current camera perspective is called for then, at 1922, a camera is selected according to the target camera perspective determined at 1918. In an embodiment, the selection of the new camera may be streamlined: the system may select from among the cameras at their current perspectives based on their respective image data sets. According to such an implementation, the system may not need first to determine a target camera perspective and then find the camera that is closest to it but, rather, select from the available cameras at their current perspectives. Or, in such an implementation, the system may select the new camera and then determine whether a finer adjustment of the position and/or the angle of the camera is to be requested to the camera selected.

In an implantation, after a target physical target camera perspective is selected, a virtual target camera perspective may be determined based on the target physical camera perspective. Starting with the target physical camera, the following operations may be undertaken to find the virtual camera perspective:
1. Interpolate virtual cameras around the target physical camera at a predetermined distance d, for example, 1-20 m, or within 0.5-100 m.
2. Determine the apparent object size, parallax effect, portion of the trajectory of the object within the field of view, and obstruction of the view of the trajectory for image data for each such virtual camera.
3. Based on operation 2 above, evaluate the Objective based on the formula (1) for image data for each such virtual camera.
4. Select a candidate virtual camera perspective based on operation 3 above.
5. Repeat operations 2-4 until no new candidate is found based on the Objective based on the formula (1). Then, if no better candidate is found, the system may proceed to step 5 to reduce the search distance
6. Reduce the value of distance d, for example, by 10-90%, around the candidate virtual camera, and repeat operations 2-4, above.
7. Select as the candidate virtual camera perspective the current one when the Objective computed based on the formula (1) determined for image data of the current virtual camera perspective is greater than for image data of a previous candidate virtual camera perspective.
8. When distance d has been reduced to a minimum threshold amount, for example, to 0.1-10 m, stop, and select as the target virtual camera perspective the current candidate virtual camera perspective.
   In an implementation, the virtual camera vantage point may be selected based two physical cameras' image data with the two physical cameras selected according to the Objective computed based on the formula (1) determined for image data of each physical camera. Thus, the system may select the two candidate physical cameras that offer the highest Objective computed based on the formula (1), and then compute virtual camera image data by interpolating the image data of these two physical cameras. Also, as discussed, the target camera perspective may be a position to which the target physical camera is moved or an angle to which it is adjusted.

At 1924, one or more intermediate camera perspective(s) may be determined according to the target camera perspective that has been determined. For example, an intermediate camera perspective may be a camera position substantially halfway between the current camera perspective and target camera perspective.

New video data may be received from the intermediate camera perspective for a period of time before the new image data is received from the selected camera at the target camera perspective at 1926. For example, the intermediate camera may provide image data for 1-8 seconds, or from 0.2 to 90 seconds. The new video data from the selected camera at the target camera perspective may continue to be provided until the object 105 lands at the landing spot. In an implementation, the new video data from the selective camera may continue to be received for a while after the object 105 lands.

In implementation, after the data feed is received from the selected camara at the target camera perspective, video data may be received again from the intermediate camera perspective for a period of time, for example 1-8 seconds, or 0.2 to 90 seconds. Then, further new video data may be received from original camera perspective, as the system switches back to the original camera perspective or to a different camera perspective according to normal processing.

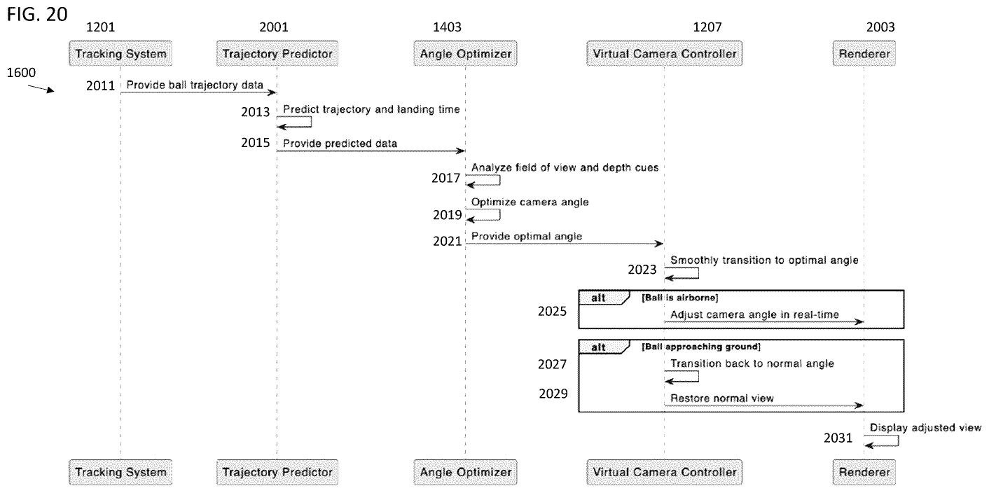

FIG. 20 is an example of a process 2000 for system communication and processing for camera selection, according to an embodiment of the disclosure. Aims of this process 2000 may include:
Initial to Target Camera Perspective Transition: Smoothly transition the camera angle from the initial position to the target perspective as the object rises or moves through its trajectory. This transition may be gradual to avoid disorienting the viewer.
Real-Time Adjustment: The camera perspective may be continually adjusted in real-time to track the object's movement and to maintain a good view.
Transition Back: As the object approaches the surface 101, the camera feed may be switched back to the original viewing perspective or to another camera perspective according the ordinary camera selection process. The timing of this transition may be coordinated with the predicted landing time to ensure a smooth return.
Normal View Restoration: The system may facilitate that the camera data feed is returned to the normal perspective just before, or as, the object lands to provide continuity in the video streaming or broadcast.

As shown at 2011, tracking system 1301 may provide object trajectory data to a trajectory predictor 2001. The trajectory predictor 2001 may be the same as, or may be provided as part of, the data fusion module 1107. The trajectory data may include data regarding current positions and/or motion of the object 105.

At 2013, trajectory predictor 2001 may predict the trajectory of the object 105 and its landing time and landing spot on the surface 101.

At 2015, trajectory predictor 14 oh one provide the predicted trajectory and landing time and landing spot on surface 102 the angle optimizer 1403.

At 2017, angle optimizer 1403 may analyze the field of view and depth cues and/or the other factors (DP, FOV, OCC) discussed in the foregoing discussion.

At 2019, angle optimizer 1403 may determine a target camera perspective based on the formula above discussed for combining the factors according to the above-discussed equation:

$$Objective = α \cdot DP + β \cdot MP + γ \cdot FOV - δ \cdot OCC$$

At 2021, the target camera perspective may be provided to virtual camera controller 2007. It will be understood that a virtual camera may not be used in all implementations. In an implementation, a virtual camera may be used only for intermediate camera perspectives between the original perspective and the target perspective.

At 2023, virtual camera controller 1207 controls smooth transition to target camera perspective by determining one or more intermediate camera perspectives, and requesting the camera at the intermediate camera perspective to provide video data.

At 2025, virtual camera controller 1207 may request renderer 2003 to adjust a position or angle of a camera to the target camera perspective.

At 2027, virtual camera controller 1207, may determine that a transition back to the original camera perspective is needed based at least in part on determining that the object 105 is approaching, but has not quite reached, the landing spot on surface 101.

At 2029, virtual camera controller 1207 may request renderer 2003 to return to providing the data feed from the original camera perspective or to another camera that is to be used.

At 2031, renderer 2003 may be requested by virtual camera controller 1207 to provide the video data according to the adjusted view.

In an embodiment, the surface 101 (e.g., the soccer field) may be rendered from the viewpoint of the airborne object (e.g., from the viewpoint of the soccer ball), using the target perspective to view the surface 101 and objects (e.g., players) thereon. Thus, a virtual camera may be oriented to face the soccer field, while an up vector of the virtual camera may be oriented to the direction of the projected 2D trajectory direction. The up vector of a camera may be thought of as representing the direction that is to be regarded as the up direction of the camera or the image captured by the camera. The system may thus position the virtual camera at the same location of the ball facing the surface 101, and also specify the up direction of the virtual camera. In this way, knowing the location and direction of this virtual camera, the system may render video seen by this virtual camera.

For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

References herein to an “XR device” may refer to a device providing virtual reality (VR), mixed or merged reality (MR), or augmented reality (AR) functionality (e.g., wherein virtual objects or graphic overlays are provided in addition to real-world objects or environments visible via the device). The terms AR and MR may sometimes be used interchangeable with XR herein. An XR device may take the form of glasses or a headset in some instances (e.g., a head-mounted display or HMD).

In an embodiment, user A of a first XR device may view a graphic 111 or other graphics and/or may view the airborne object 105 in a game or other event from a target camera perspective, while user B watching the same event and wearing a second XR device, or wearing no XR device, views no graphic 111 or other graphics and/or may view 101 the airborne object 105 from the original camera perspective. For example, an XR device may allow a user to select an enhanced graphics and/or enhanced camera perspective. Video data with graphics and without graphics, and from different cameras, may be streamed or broadcast simultaneously. Accordingly, an actionable item or button to command “graphics enhanced” content item and/or “perspective enhanced” content item may be selected by the viewer.

One or more actions of the methods 900-1600 and 1800-2000 may be incorporated into or combined with one or more actions of any other process or embodiments described herein. These and other methods described herein, or portions thereof, may be saved to a memory or storage (e.g., of the systems shown in FIGS. 7 and 8) or locally as one or more instructions or routines, which may be executed by any suitable device or system having access to the memory or storage to implement these methods.

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be effected to the particular embodiments by those of skill in the art without departing from the scope of the present application, which is defined solely by the claims appended hereto. Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1-10. (canceled)

11. A computer-implemented method comprising:
receiving first image data captured from a first perspective by a first physical camera and second image data captured from a second perspective by a second physical camera, wherein the first image data and the second image data indicate a sequence of object positions;
predicting in real time a trajectory of the object in three-dimensional (3D) space;
for each of the first image data and the second image data:
determining an apparent size of the object;
determining a parallax effect for the object based at least in part on an analysis of respective image data compared with updated image data computed by a simulated change in angle of a respective physical camera; and
determining a viewable portion of the trajectory of the object;
selecting, as a selected camera, one of the first physical camera or the second physical camera based at least in part on the determined apparent size of the object, the determined motion parallax effect for the object, or the determined viewable portion of the trajectory of the object; and
receiving, using the selected camera, new image data of at least a portion of the trajectory of the object.

12. The method of claim 11, further comprising:
determining at least one intermediate perspective between a perspective of the selected camera and an original camera angle;
receiving intermediate camera image data of the object from the at least one intermediate perspective before the receiving the new image data of the object from the selected camera.

13. The method of claim 11, wherein the trajectory of the object in the three-dimensional space is predicted based at least in part on data received from one more sensors at the object.

14. The method of claim 11, wherein the trajectory of the object in the three-dimensional space is predicted based at least in part on the first image data or the second image data.

15. The method of claim 11, wherein the viewable portion of the trajectory of the object is determined with respect to an entirety of the trajectory of the object.

16. The method of claim 11, wherein the apparent size of the object is determined based at least in part on a pixel count in one or more video frames.

17. The method of claim 11, further comprising:
evaluating an objective value for image data computed for first virtual cameras at a first distance from the selected physical camera, wherein the objective value is computed based at least in part by determining an apparent size of the object, determining a parallax effect for the object based at least in part on an analysis of the respective image data compared with update image data computed by a simulated change in angle of a respective virtual camera, and determining a viewable portion of the trajectory of the object;
selecting as a first candidate virtual camera the virtual camera with a greater objective value;
computing a second distance less than the first distance;
evaluating the objective value for image data computed for second virtual cameras at the second distance from the candidate virtual camera, wherein the objective value is computed based at least in part by determining an apparent size of the object, determining a parallax effect for the object based at least in part on an analysis of the respective image data compared with update image data computed by a simulated change in angle of the respective virtual camera, and determining a viewable portion of the trajectory of the object;
determining that the image data of one virtual camera of the second virtual cameras has the objective value greater than the objective value of the image data of the first candidate virtual camera; and
selecting the one virtual camera of the second candidate virtual cameras as the target virtual camera.

18. The method of claim 11, wherein the viewable portion of the trajectory of the object is determined based at least in part on a visibility of the trajectory of the object in a field of view from a camera perspective and based at least in part on one or more obstructions determined in the field of view from the camera perspective.

19. The method of claim 11, further comprising: repositioning the selected camera according to the determined camera perspective.

20. The method of claim 11, wherein the trajectory of the object is predicted by computing at least two coordinates in 3D space indicating successive positions of the object, and determining a time interval between the at least two coordinates.

21. The method of claim 11, further comprising:
determining, based at least in part on a position of the object in the video data, a location of the object in 3D space with respect to a surface; and
inserting a graphic in the video data underneath the object indicating on the surface a location corresponding to the position of the object.

22. A computer-implemented method comprising:
receiving first video data captured from a first camera perspective by a physical camera; predicting in real time a trajectory of the object in 3D space;
selecting a target camera perspective for capturing the trajectory of the object based at least in part on an apparent size of the object from a plurality of candidate camera perspectives, a parallax effect of the object from a plurality of candidate camera perspectives, wherein the parallax effect is computed based at least in part on an analysis of respective image data compared with updated image data computed by a simulated change in angle of a respective physical camera, or a viewable portion of the trajectory of the object from the plurality of candidate camera perspectives; and
receiving new video data from the selected target camera perspective.

23. The method of claim 22, further comprising:
determining a virtual camera perspective based at least in part on the selected physical camera perspective.

24-33. (canceled)

34. A computer-implemented system comprising:
a memory; and
control circuitry configured to:
receive first image data captured from a first perspective by a first physical camera and second image data captured from a second perspective by a second physical camera, wherein the first image data and the second image data indicate a sequence of object positions, and store the sequence of object positions in the memory;
predict in real time a trajectory of the object in three-dimensional (3D) space;
for each of the first image data and the second image data:
determine an apparent size of the object;
determine a parallax effect for the object based at least in part on an analysis of respective image data compared with updated image data computed by a simulated change in angle of a respective physical camera; and
a viewable portion of the trajectory of the object;
select, as a selected camera, one of the first physical camera or the second physical camera based at least in part on the determined apparent size of the object, the determined motion parallax effect for the object, or the determined viewable portion of the trajectory of the object; and
receive, using the selected camera, new image data of at least a portion of the trajectory of the object.

35. The system of claim 34, wherein the system is configured to:
determine at least one intermediate perspective between a perspective of the selected camera and an original camera angle; and
receive intermediate camera image data of the object from the at least one intermediate perspective before the receiving the new image data of the object from the selected camera.

36. The system of claim 34, wherein the trajectory of the object in the three-dimensional space is predicted based at least in part on data received from one more sensors at the object.

37. The system of claim 34, wherein the trajectory of the object in the three-dimensional space is predicted based at least in part on the first image data or the second image data.

38. The system of claim 34, wherein the viewable portion of the trajectory of the object is determined with respect to an entirety of the trajectory of the object.

39. The system of claim 34, wherein the apparent size of the object is determined based at least in part on a pixel count in one or more video frames.

40. The system of claim 34, wherein the system is configured to:
evaluate an objective value for image data computed for first virtual cameras at a first distance from the selected physical camera, wherein the objective value is computed based at least in part by determining an apparent size of the object, determining a parallax effect for the object based at least in part on an analysis of the respective image data compared with update image data computed by a simulated change in angle of a respective virtual camera, and determining a viewable portion of the trajectory of the object;
select as a first candidate virtual camera the virtual camera with a greater objective value;
compute a second distance less than the first distance;
evaluate the objective value for image data computed for second virtual cameras at the second distance from the candidate virtual camera, wherein the objective value is computed based at least in part by determining an apparent size of the object, determining a parallax effect for the object based at least in part on an analysis of the respective image data compared with update image data computed by a simulated change in angle of the respective virtual camera, and determining a viewable portion of the trajectory of the object;
determine that the image data of one virtual camera of the second virtual cameras has the objective value greater than the objective value of the image data of the first candidate virtual camera; and
select the one virtual camera of the second candidate virtual cameras as the target virtual camera.

41-113. (canceled)
